(19) United States
(12) Patent Application Publication
(10) Pub. No.: US 2026/0303234 A1
(43) Pub. Date: Oct. 1, 2026

(54) SYSTEM AND METHOD FOR A RECONFIGURABLE METASURFACE UNIT CELL ARRAY TO ALLOCATE WIRELESS CHANNELS WITH METASURFACE SLICING

(71) Applicant: Dell Products LP, Round Rock, TX (US)

(72) Inventors: Harpreet S. Narula, Austin, TX (US); Tejinder Singh, Manotick (CA); Navjot Kaur Khaira, Manotick (CA)

(73) Assignee: Dell Products LP, Round Rock, TX (US)

(21) Appl. No.: 19/097,104

(22) Filed: Apr. 1, 2025

(51) Int. Cl. H04B 17/318; H04B 7/04; H04B 7/06

(52) U.S. Cl. CPC H04B 17/328; H04B 7/04013; H04B 7/0617

(57) ABSTRACT

A system and method for operating a reconfigurable metasurface unit cell array includes a reconfigurable metasurface microcontroller unit (MCU) to receive real-time network data from an access point describing received signal strength indicator (RSSI) levels of a plurality of wireless transmissions within a radiofrequency environment and a plurality of channel-specific RSSI threshold levels. The reconfigurable metasurface MCU executes machine readable code instructions of a dynamic metasurface configuration system to determine, for each of the plurality of wireless transmissions within the radiofrequency environment, whether channel-specific RSSI levels have fallen below the channel-specific RSSI threshold levels. When channel-specific RSSI levels have fallen below one or more of the plurality of channel-specific RSSI threshold levels, the reconfigurable metasurface MCU adjusts one or more subsections of addressable reconfigurable metasurface unit cells within the reconfigurable metasurface unit cell array to increase RSSI levels for a wireless transmission reflected by one or more subsections.

### FIELD OF THE DISCLOSURE

The present disclosure generally relates to metasurface systems for reflecting or directing radiofrequency signals used in wireless communications for information handling systems in a radiofrequency environment. The present disclosure more specifically relates systems and methods for a reconfigurable metasurface that dynamically adjusts subsections of reconfigurable metasurface unit cells within the reconfigurable metasurface unit cell array to beamform a plurality of wireless transmissions within the radiofrequency environment and increase the signal strength, such as received signal strength indicator (RSSI) levels of the plurality of wireless transmissions amongst a plurality access points and wireless information handling systems in the radiofrequency environment.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities that may include wireless communications. The information handling system may be used to operate a wireless interface adapter and radio system for transmission of radio signals to a receiving wireless device or access point device or to receive radio signals from the wireless device or access point device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing machine readable code instructions of a reconfigurable metasurface unit cell array selection control agent and wirelessly interfacing with a reconfigurable metasurface unit cell array to dynamically and partition the reconfigurable metasurface unit cell array for allocated channels according to an embodiment of the present disclosure;

FIG. 2 is a block diagram illustrating a reconfigurable metasurface unit cell array executing machine readable code instructions of a dynamic metasurface configuration system to partition the reconfigurable metasurface unit cell array for dynamically allocated channels to wirelessly interface with one or more information handling systems and an access point according to another embodiment of the present disclosure;

FIG. 3 is a side, exploded graphic diagram illustrating a perspective view of a plurality of reconfigurable metasurface unit cells of at least part of a reconfigurable metasurface unit cell array that may form one or more partitioned subsections of reconfigurable metasurface unit cells within the reconfigurable metasurface unit cell array to beamform the plurality of wireless transmissions of allocated channels in a radiofrequency environment according to an embodiment of the present disclosure;

FIG. 4 is a graphic and block diagram of a radiofrequency environment that includes a reconfigurable metasurface unit cell array, an access point or base station, and a plurality of information handling systems according to an embodiment of the present disclosure;

FIG. 5 is a block diagram of a reconfigurable metasurface unit cell array segmented into a plurality of subsections of metasurface unit cell units via operation of a metasurface controller and reconfigurable metasurface microcontroller unit (MCU) executing machine readable code instructions of a dynamic metasurface configuration system according to an embodiment of the present disclosure;

FIG. 6 is a graphic and block diagram of a radiofrequency environment with a reconfigurable metasurface unit cell array segregated into a plurality of subsections via execution of machine readable code instructions of a dynamic metasurface configuration system by a reconfigurable metasurface MCU that is operatively and wirelessly coupled to an access point via a sideband communication channel according to an embodiment of the present disclosure;

FIG. 7 is a swimlane process flow diagram of a method of executing machine readable code instructions of a dynamic metasurface configuration system for allocating subsections of a reconfigurable metasurface unit cell array for allocated wireless channels according to an embodiment of the present disclosure; and

FIG. 8 is a block diagram of a method of executing machine readable code instructions of a dynamic metasurface configuration system for allocating subsections of a reconfigurable metasurface unit cell array for allocated wireless channels according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid data transmission and communication between multiple devices. Devices may include wirelessly enabled information handling systems, access point devices, or any computing device, such as internet of things (IoT) devices that are wirelessly capable. As data transmission requirements increase, the electromagnetic (EM) waves (e.g., 5G technologies using 20 to 50 GHz wireless signals or WiFi signals at 2.4 GHz, 5 GHz or even 6 GHz) used to transmit these ever-increasing amounts of data are shortened or may benefit from extended range such as reach around radiofrequency barriers such as walls. Concurrently, legacy wireless devices may still operate at relatively lower frequencies. However, in modern wireless communication systems, the optimization of channel allocation and signal propagation is necessary to achieve high efficiency and quality of service (QoS). Traditional wireless channel allocation systems are limited by including static infrastructure and limited adaptability that lead to inefficiencies in spectrum usage, congestion, and interference.

Embodiments of the present specification describes a system and method of dynamically allocating channels within a wireless spectrum and dynamically adjusting subsections of reconfigurable metasurface unit cells within a reconfigurable metasurface unit cell array in order to accommodate for the relaying of a plurality of wireless transmissions in a radiofrequency environment between access points and one or more wireless information handling systems. Further, the system and method of dynamically adjusting subsections of reconfigurable metasurface unit cells within a reconfigurable metasurface unit cell array may accommodate relaying of a plurality of wireless transmissions of allocated channels in a radiofrequency environment at a plurality of different frequencies on a plurality of those wireless channels in embodiments herein. In an embodiment, a reconfigurable metasurface unit cell array includes a reconfigurable metasurface microcontroller unit (MCU) to receive real-time network data from an access point in the radiofrequency environment. This real-time network data may describe received signal strength indicator (RSSI) data associated with a plurality of wireless transmissions of a plurality of wireless information handling systems within the wireless network. Further, real-time network data may be received from an access point, wireless information handling system, or other radiofrequency environment control consol to include a plurality of channel-specific RSSI threshold levels set by an information technology decision maker (ITDM). With this data, the reconfigurable metasurface MCU may execute machine readable program code instructions of a dynamic metasurface configuration system to determine, for each of the plurality of wireless transmissions of a plurality of wireless information handling systems within the wireless network, whether channel-specific RSSI levels have fallen below one or more of the plurality of channel-specific RSSI threshold levels. Thus, the reconfigurable metasurface MCU may, when channel-specific RSSI levels have fallen below one or more of the plurality of channel-specific RSSI threshold levels, determine how to partition subsections of reconfigurable metasurface unit cells and generate signals to a metasurface controller to adjust designated subsections of those reconfigurable metasurface unit cells within the reconfigurable metasurface unit cell array to adjust beamforming for one or more of those plurality of wireless transmissions. Adjustment of the size of the partitioned subsections of reconfigurable metasurface unit cells may increase the RSSI levels of those wireless transmissions to receiver wireless information handling systems that have fallen below the channel-specific RSSI levels have fallen below one or more of the plurality of channel-specific RSSI threshold levels in embodiments herein.

In an embodiment of the present disclosure, the reconfigurable metasurface unit cells are formed of a substrate, such as a dielectric material, with one or more conductive resonant structures formed therein that are reconfigurable. The conductive resonant structures are formed such that dimensions and distances of those conductive resonant structures cause phase shift of incoming electromagnetic (EM) waves for wireless frequencies in embodiments herein. In an embodiment, the resonant structures may be reconfigurable with adjustable structures such as adjustable varactors, capacitors, or phase-change materials to change the phase shifting of incoming EM waves by that reconfigurable metasurface unit cell. In some embodiments, the resonant structures of the reconfigurable unit cells are adjustable with control voltages or power such that the reconfigurable metasurface unit cells are addressable by the reconfigurable metasurface MCU and metasurface controller to adjust phase shifting and operation with other adjacent reconfigurable metasurface unit cells. In a further embodiment, the reconfigurable metasurface unit cells are formed of the substrate with a conductive backing layer, such as a metal layer, with conductive vias through the conductive backing layer and substrate to address the reconfigurable structures of the resonant structure layer of the reconfigurable metasurface unit cell.

In one embodiment, the reconfigurable metasurface unit cell includes a center node and an outer ring structure with one or more metasurface reconfigurable split rings comprising a state change material with corresponding refractory heaters to switch the corresponding metasurface reconfigurable split rings between a conductive state and dielectric state to adjust capacitance and resonant structures of the reconfigurable metasurface unit cell. In an embodiment, the reconfigurable metasurface MCU may selectively provide power to some portion of the plural refractory heaters to change the electromagnetic reflective properties of the reconfigurable metasurface unit cell resonant structures among the array of reconfigurable metasurface unit cells to conduct beamforming in one or more subsections. In another embodiment, the reconfigurable metasurface unit cells include a plurality of metasurface switchable capacitance structures to switch the corresponding capacitance of the resonant structures of the reconfigurable metasurface unit cell. In an embodiment, the reconfigurable metasurface MCU may selectively switch some portion of the capacitance of the reconfigurable metasurface unit cells to change the electromagnetic reflective properties by adjusting phase shift of incoming EM waves at each reconfigurable metasurface unit cell to conduct beamforming with constructive and destructive interference across subsections of the reconfigurable metasurface unit cell array. In an embodiment, the reconfigurable metasurface unit cells are arranged within the reconfigurable metasurface unit cell array in columns and rows for the reconfigurable metasurface MCU to adjust subsections of subgroups of designated reconfigurable metasurface unit cells to include addition of neighboring cells from one or more rows in one or more columns to a subsection for reflection of an allocated channel for a wireless transmission being reflected by the reconfigurable metasurface unit cell array. With an increase in the size of a subsection of reconfigurable metasurface unit cells for an allocated wireless transmission channel, an increase of the beamforming lobe and, thus, the gain of the redirected EM wave may be realized by adjusting the sizes of one or more subsections of the reconfigurable metasurface unit cell array according to embodiments herein. The number of reconfigurable metasurface unit cells attributed to the subsection as well as adjustment to resonant structures of each added (or subtracted) reconfigurable metasurface unit cell via addressability by the reconfigurable metasurface MCU are part of the execution of machine readable code instructions of the dynamic metasurface configuration system according to embodiments of the present disclosure.

In an embodiment, the reconfigurable metasurface MCU may establish a side band communication with the access point, via a reconfigurable metasurface wireless adapter that may include an antenna and radio, to report adjustments to the subsections of the reconfigurable metasurface unit cell array. This reporting may further provide the access point with data on adjustment to the beamformed plurality of wireless transmissions and increases in the RSSI levels of one or more of the plurality of wireless transmissions for communications with a plurality of wireless information handling system within the radiofrequency environment in embodiments herein.

In an embodiment, the real-time network data received at a reconfigurable metasurface wireless adapter may further include channel state information describing how the plurality of wireless transmissions are transmitted between each of the transmitter device, such as an access point, and the receiver device, such as a wireless information handling system, in terms of amplitude and phase. Thus, the metasurface MCU, operatively coupled to a metasurface controller such as a metasurface controller field programmable gate array (FPGA), may access a look-up table defining how the metasurface controller FPGA is to address and activate each of the reconfigurable metasurface unit cells of the reconfigurable metasurface unit cell array into an adjusted subsection of reconfigurable metasurface unit cells within the reconfigurable metasurface unit cell array. As described, the metasurface controller FPGA may address and activate each of the reconfigurable metasurface unit cells to activate a reconfigurable structure to adjust reconfigurable resonant structures of that reconfigurable metasurface unit cell to adjust its phase shifting properties on incoming EM waves. In other embodiments described herein, the real-time network data includes device-specific optimization data, gray list data, and device prioritization data. In an embodiment, the dynamic metasurface configuration system includes a deep reinforcement learning algorithm executing on a reconfigurable metasurface MCU to receive the RSSI data, device-specific optimization data, gray list data, device prioritization data or other real-time network data. The execution of machine readable code instructions of the dynamic metasurface configuration system includes a deep reinforcement learning algorithm adjusts subsections of reconfigurable metasurface unit cells within the reconfigurable metasurface unit cell array to tailor the beamforming for reflection of each of the plurality of wireless transmissions of allocated channels reflected by the subsections of the reconfigurable metasurface unit cell array. For example, increasing the reconfigurable metasurface unit cells in a subsection may be used to increase the RSSI levels of the wireless transmission for an allocated channel to one or more wireless information handling systems in the radiofrequency environment with low RSSI levels or high device prioritization in some embodiments.

Thus, the presently-described reconfigurable metasurface unit cell array of embodiments herein leverages a machine readable code instructions of a dynamic metasurface configuration system executing at a reconfigurable metasurface MCU to dynamically manage the slicing, partitioning, and segmentation configuration of a reconfigurable metasurface unit cell array for optimal channel allocation for wireless transmissions reflected by the reconfigurable metasurface unit cell array in a radiofrequency environment. The architecture includes a reconfigurable metasurface MCU and metasurface controller that interfaces, via a reconfigurable metasurface wireless adapter, with an access point (AP) or base station (BS) to receive real-time network data, such as user density, device prioritization and gray lists, real time signal quality metrics, as well as other network characteristics and environmental factors. With this data, execution of the dynamic metasurface configuration system with a deep reinforcement learning algorithm may be trained to predict the optimal configuration of subsections of the metasurface unit cell array and instruct the metasurface controller how to adjust the reflection and transmission properties of the metasurface unit cells to operate in a given, designated subsection. In this way, the adjustment of reconfigurable metasurface unit cells allocated to the subsections of reconfigurable metasurface unit cell array may be made to beam steer one or more wireless signals and allocate channels effectively for improved signal strength where needed within the radiofrequency environment. By continuously learning from the radiofrequency environment and network data, the dynamic metasurface configuration system can adapt to changing conditions, such as user movement or varying interference levels, and make real-time adjustments to maximize network performance. The systems and methods described herein may also incorporate a feedback loop where the system's performance is monitored, and the dynamic metasurface configuration system with a deep reinforcement learning algorithm is updated to refine its decision-making process. This system and method may enhance spectrum efficiency, reduce interference, and ensures consistent wireless quality of service (QoS), such as signal strengths, to receiver wireless information handling systems within a radiofrequency environment thereby offering a scalable and flexible framework for wireless networks.

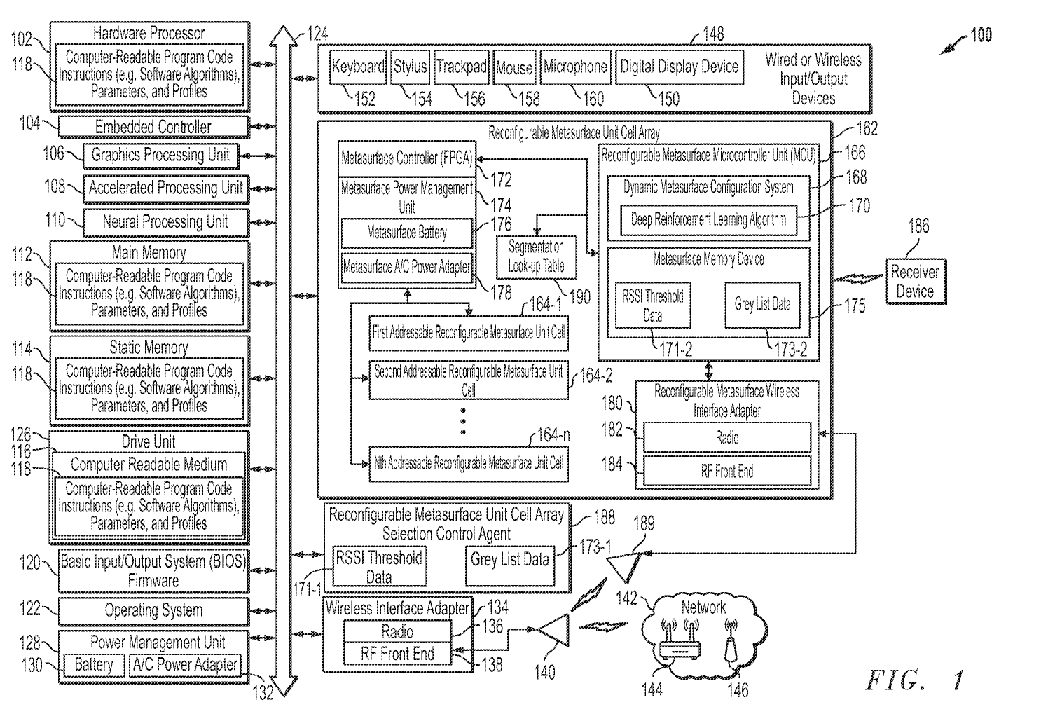

Turning now to the figures, FIG. 1 illustrates an information handling system 100 similar to the information handling systems according to several aspects of the present disclosure that may operate as a source or target radiofrequency device for use with the reconfigurable metasurfaces of the embodiments of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Machine readable program code instructions stored in static memory 114, main memory 112, or drive unit 126 may be involved in invoking such machine readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute machine readable program code instructions (e.g., software algorithms) parameters, and profiles 118 that may operate on servers or systems, remote data centers, or on-box in individual client information handling systems according to various embodiments herein. In some embodiments, it is understood that any or all portions of machine readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing machine readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, the wireless interface device 134 with its radio 136, RF front end 138 and antenna 140 is used to communicate with a WWAN or and WLAN which may each include an AP 144 or base station 146 used to operatively couple the information handling system 100 to a network 142 via the wireless interface adapter 134 such as part of a radiofrequency environment. In a specific embodiment, the network 142 may include macro-cellular connections via one or more base stations 146 or a wireless AP 144 (e.g., Wi-Fi), or such as through licensed or unlicensed WWAN small cell base stations 146 in a radiofrequency environment. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with a target receiver device 178 via the reconfigurable metasurface unit cell array 162. The receiver device 178 may be any other device and may include the AP 144, the base station 146, or any other computing device described herein. Additionally, the information handling system 100 and receiver device 178 may be capable of transmitting wireless data using, for example, EM waves that include 5G mm wave lengths such as those included within the 20-50 GHz range or WiFi wavelengths such as 2.4 GHz, 5 GHz, 6 GHz or others to be used with later versions of WiFi. Thus, in an embodiment, the reconfigurable metasurface unit cell array 162 is capable of relaying these types of mm waves.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes machine readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing machine readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a machine readable medium that includes machine readable program code instructions, parameters, and profiles 118 or receives and executes machine readable program code instructions, parameters, and profiles 118 responsive to a propagated signal, so that a hardware device connected to a network 142 may communicate voice, video, or data over the network 142. Further, the machine readable program code instructions, parameters, and profiles 118 may be transmitted or received over the network 142 via the network interface device or wireless interface adapter 134.

The information handling system 100 may include a set of machine readable program code instructions, parameters, and profiles 118 that may be executed to cause the computer system to perform any one or more of the methods or computer-based functions disclosed herein. For example, machine readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application machine readable program code instructions, parameters, and profiles 118 may be coordinated by an operating system (OS) 122, and/or via an application programming interface (API) include a unified device API described herein. An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a machine readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain machine readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain machine readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the machine readable medium is shown to be a single medium, the term “machine readable medium” includes a single medium or multiple media, such as a centralized or distributed database, and/or associated caches and servers that store one or more sets of machine-readable code instructions. The term “machine readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the machine readable medium can include a solid-state memory such as a memory card or other package that houses one or more non-volatile read-only memories. Further, the machine readable medium can be a random-access memory or other volatile re-writable memory. Additionally, the machine readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a machine readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may operatively communicate with a receiver device 178 (e.g., another information handling system, an AP 144, a base station 146, etc.) via an intermediary-placed reconfigurable metasurface unit cell array 162. This reconfigurable metasurface unit cell array 162 may be configured to relay or otherwise reflect wireless EM waves transmitted from, for example, the information handling system 100 or other transmitting device, such as access point 144 or base station 146, and may extend the wireless range or improve signal of the information handling system 100 other transmitting device in communications with a target wireless device such as the receiving device 178. Again, these EM waves may include any type of EM wave including low-band, mid-band, or high-band millimeter-wave EM waves. These may include 600-900 MHz, 1.7-6 GHz, and 24-47 GHz, among other frequencies.

During operation, the information handling system 100 may execute machine readable program code instructions of a reconfigurable metasurface unit cell array selection control agent 188. The reconfigurable metasurface unit cell array selection control agent 188 may allow a user such as an internet technology decision maker (ITDM) to set minimum RSSI thresholds for any of a plurality of channels within any given frequency band. For example, the hardware processor 102 of the information handling system 100 may execute the machine readable program code instructions of the reconfigurable metasurface unit cell array selection control agent 188 to provide a graphical user interface (GUI) to a user so that these RSSI threshold data 141-1 defining RSSI threshold levels can be set at, for example, -75 dBm to ensure reliable wireless connections. In other embodiments, the reconfigurable metasurface unit cell array selection control agent 188 may be used to set receiver device prioritization or gray lists or other factors that may be set by an ITDM managing wireless communications in a radiofrequency environment. In an embodiment, a reconfigurable metasurface MCU 166 may use this RSSI threshold data 171-1, gray list data 173-1, device prioritization data or other data, to dynamically adjust the size and creation of individual subsections of the reconfigurable metasurface unit cell array 162 for reflecting one or more wireless transmissions of allocated channels within a wireless network. Allocated channels may be established for particular frequencies of allocated channels via network dynamic channel allocation to avoid congestion and then adjustments and allocation of reconfigurable metasurface unit cells in subsections for reflecting those allocated channels in a radiofrequency environment.

For example, the size of the created subsections may be defined by the number of metasurface unit cells included within the subsections (e.g., first reconfigurable metasurface unit cell 164-1, second reconfigurable metasurface unit cell 164-2, Nth reconfigurable metasurface unit cell 164-n). An increased subsection size in terms of number of allocated reconfigurable metasurface unit cells may provide for beamforming with improved radiofrequency signal gain for a particular allocated channel in some embodiments. In other embodiments, a subsection may be reduced when adequate RSSI levels are detected or de-prioritization of those allocated channels is identified. In this way, the reconfigurable metasurface unit cell array may be dynamically partitioned into subsections corresponding to allocated channels of wireless transmissions in the radiofrequency environment through addressability of each of the reconfigurable metasurface unit cells in the reconfigurable metasurface unit cell array in embodiments herein.

In an embodiment, as the user sets the RSSI threshold data 171 and gray list data 173 identifying device prioritization or de-prioritization at the reconfigurable metasurface unit cell array selection control agent 188, these RSSI thresholds may be sent to the metasurface controller 172 of the metasurface unit cell array 162. In an embodiment, the RSSI threshold data 171 and gray list data 173 may be associated with the reconfigurable metasurface unit cell array selection control agent 188 and stored on a memory device of the information handling system 100 such as the main memory 112. If, in an example embodiment, the metasurface unit cell array 162 is affixed to a surface of the information handling system 100 such as a lid, the hardware processor 102 may be used in place of the reconfigurable metasurface MCU 166 and/or metasurface controller 172. Whether the machine readable program codes instructions of the reconfigurable metasurface unit cell array selection control agent 188 are executed by the hardware processor 102 or the reconfigurable metasurface MCU 166, the RSSI thresholds (e.g., RSSI threshold data 171-2 stored on a metasurface memory device 175) may be used by a dynamic metasurface configuration system 168, executing machine readable program code instructions of a deep reinforcement learning algorithm 170, to determine, in real-time, whether RSSI levels of any given wireless transmission are being met relative to the set RSSI threshold levels and dynamically allocate channels within the wireless network to avoid congestion and improve RSSI levels. It is appreciated that the grey list data 173-1 stored on a memory device of the information handling system, may also be transmitted, wirelessly, to the reconfigurable metasurface MCU 166 and stored on the metasurface memory device 175 as grey lists data 173-2 maintained by the reconfigurable metasurface unit cell array 162. In an embodiment, the reconfigurable metasurface MCU 166 may access a segmentation look-up table 190 to define how the dynamically-created reconfigurable metasurface unit cell subsections are to be adjusted using in size by addressing each of plurality of addressable reconfigurable metasurface unit cells 164-1, 164-2, 164-n to allocate to or de-allocate them from a subsection of the reconfigurable metasurface unit cell array 162.

During operation, the user of the information handling system 100 may also be operatively coupled to the access point 144, base station transceiver 146, or other wireless transceiver. This may allow, in an example embodiment, for the access point 144, for example, to detect subsection allocation and reconfigurable metasurface unit cell utilization data received from the reconfigurable metasurface MCU 166 of the metasurface unit cell array 162. This subsection allocation and reconfigurable metasurface unit cell utilization data and other real-time wireless network data may be sent from the metasurface unit cell array 162 using, in an embodiment, a reconfigurable metasurface wireless interface adapter 180 that includes a metasurface radio 182, a metasurface RF front end 184, and a metasurface antenna 189. In an embodiment, this reconfigurable metasurface wireless interface adapter 180 may establish a side-band communication channel with the access point 144, base station transceiver 146, or other wireless transceiver in the wireless network to relay the subsection allocation and reconfigurable metasurface unit cell utilization data as well as for the reconfigurable metasurface unit cell array to receive real time network data such as signal strength information or RSSI threshold levels.

The reconfigurable metasurface MCU 166 may, therefore, act as a decision-making device in part that instructs the access point 144 or other transceiving device how to allocate channels within any given frequency band to prevent congestion, increase spectrum usage, and prevent interference within any given frequency band based on subsection allocation and reconfigurable metasurface unit cell utilization data of available subsections of the reconfigurable metasurface unit cell array 162 in a radiofrequency environment. Periodically, or in real-time, the reconfigurable metasurface MCU 166 may request real-time network data and provide control commands to the access point 144 describing which wireless transmissions to be allocated to a specific channel that may then also be allocated a subsection of the reconfigurable metasurface unit cell array for reflection and extension of that wireless transmission on that dynamically allocated channel. Concurrently, the reconfigurable metasurface MCU 166 may execute the machine readable program code of the dynamic metasurface configuration system 168 with its deep reinforcement learning algorithm 170 to receive the real-time network data and engage in the segmentation of the plurality of reconfigurable metasurface unit cells within the metasurface unit cell array 162 in order to provide an EM wave-reflective subsection of the metasurface unit cell array 162 that can be used to reflect those EM waves at those frequencies of the allocated channels for wireless transmissions in the radiofrequency environment to a receiver device 186 as directed to the access point 144 according to embodiments herein.

In an embodiment, the real-time network data may include device-specific optimization data, gray list data, and device prioritization data as well as those other types of real-time network data described herein. For example, the gray list data 173-2 and device prioritization data may be received from a user of the information handling system 100 via execution of the reconfigurable metasurface unit cell array selection control agent 188 as described herein. The gray list data may include data describing network devices that may require targeted signal enhancement such as adjustments to a subsection of the metasurface unit cell array 162 to focus EM signals from or directed towards those network devices or reassigning those network devices to different channels. The optimization data may include device specific optimization data maintained on, for example, a database that describes a plurality of wireless network connected devices including information related to historic location data and connectivity patterns. The prioritization data may include user-defined priorities that should receive prioritized treatment such as boosting Wi-Fi strength or dynamically allocating channels to improve connectivity. The dynamic metasurface configuration system 168 executing the deep reinforcement learning algorithm 170 may receive all of these types of real-time network data as input and, as output, provide an optimized configuration of the metasurface unit cell array 162 and control commands to the access point 144 (or other transceiving network devices such as a base station transceiver 146) for allocating metasurface unit cells into particular subsections for reflection of one or more wireless transmissions within a radiofrequency environment. Again, this process may be continuously executed with the reconfigurable metasurface MCU 166 monitoring for any changes in RSSI data, new or returning network devices within the wireless network, gray list data, device-specific optimization data and other real-time network data.

As described herein, as the metasurface optimization configuration data is used by the reconfigurable metasurface MCU 166 during the execution of the dynamic metasurface configuration system 168 (and its deep reinforcement learning algorithm 170) to determine allocation of reconfigurable metasurface unit cells into designated subsections and direct a metasurface controller 172 to address each of the individual reconfigurable metasurface unit cells within the metasurface unit cell array 162 such that the subsections are created or adjusted for wireless transmissions as described herein. The adjustment and realignment of these subsections may be completed based on the wireless transmissions at allocated channels to be reflected and enhanced within the radiofrequency environment by those subsections of the metasurface unit cell array 162 according to embodiments herein.

In an embodiment, the reconfigurable metasurface MCU 166 may execute machine readable code instructions of the dynamic metasurface configuration system 168 to determine, for each of the plurality of wireless transmissions with a plurality of wireless information handling systems 100 within an radiofrequency environment, whether channel-specific RSSI levels have fallen below one or more of the plurality of channel-specific RSSI threshold levels. Where those channel-specific RSSI levels have dropped, the reconfigurable metasurface MCU 166 may address specific reconfigurable metasurface unit cells 164-1 to 164-n within the metasurface unit cell array 162 to reallocate and reassign a number of reconfigurable metasurface unit cells 164-1 to 164-n into or out of a given dynamically-created reconfigurable metasurface unit cell subsection. It is appreciated that the creation or adjustment of these dynamically-created reconfigurable metasurface unit cell subsection within the metasurface unit cell array 162 may be conducted based on channel use and RSSI levels for any given channel. It is appreciated that the reconfigurable metasurface unit cell array 162 may include any type of metasurface technology that may be used to receive and reflect transmitted EM waves from a transmitter device to a receiver device. For example, as described herein, the reconfigurable metasurface unit cell array 162 may include any type of reconfigurable metasurface unit cell that incorporates reconfigurable devices such as varactor diodes (e.g., commercial-off-the-shelf (COTS) varactor diodes), capacitor banks (e.g., COTS capacitor banks), integrated switch capacitors, monolithic phase delay elements, and/or monolithic phase shifters for adjustment of capacitive resonant structures of reconfigurable metasurface unit cells in embodiments herein.

In a specific embodiment, the reconfigurable metasurface unit cell array 162 may include an array of rings of phase change material or non-volatile phase change material that, when heated, may be transformed between two distinct states: an amorphous state and a crystalline state. For ease in explanation, the reconfigurable metasurface unit cell array 162 described herein may include this array of rings of phase change material or non-volatile phase change material that, when heated, may be transformed between two distinct states: an amorphous state that is dielectric and a crystalline state that is conductive thereby providing reconfigurable device structures within resonant structures of each reconfigurable metasurface unit cell in embodiments herein. The array of rings may be round, oval or other geometric shape and may be concentric in some embodiments. The reconfigurable device structures may be addressable by the reconfigurable metasurface MCU 166 or metasurface controller (FPGA) 172 by providing voltage or other control signal to a heater to change the state phase of the rings or to adjust capacitance of another reconfigurable structure for the resonant structures of the reconfigurable metasurface unit cells according to embodiments herein.

The reconfigurable metasurface unit cell array 162 may include a plurality of addressable reconfigurable metasurface unit cells, such as the first addressable reconfigurable metasurface unit cell 164-1, a second addressable reconfigurable metasurface unit cell 164-2, and an nth addressable reconfigurable metasurface unit cell 164-n as shown in FIG. 1. It is appreciated that the reconfigurable metasurface unit cell array 162 may contain any number of addressable reconfigurable metasurface unit cells 164-1, 164-2 164-n. In one example embodiment, the reconfigurable metasurface unit cell array 162 may contain two-hundred and fifty-six addressable reconfigurable metasurface unit cells 164-1, 164-2 164-n arranged in a sixteen-by-sixteen array. It is appreciated that the reconfigurable metasurface unit cell array 162 may include any plurality of addressable reconfigurable metasurface unit cells 164-1, 164-2 164-n in any arrangement of those addressable reconfigurable metasurface unit cells 164-1, 164-2 164-n in various embodiments herein. As described herein, the addressable reconfigurable metasurface unit cells 164-1, 164-2, or 164-n within the reconfigurable metasurface unit cell array 162 may be used to, in real-time, reconfigure its reflective properties to control the reflection and steering of incoming EM waves from a transmitting source (e.g., the wireless antenna 140 of the wireless interface adapter 134 of the information handling system 100, an AP 144, or other transmitter device) to a receiver device 186 via constructive or destructive interference among neighboring addressable reconfigurable metasurface unit cells 164-1, 164-2, or 164-n for beam forming by subsections according to embodiments herein.

As described herein, the reconfigurable metasurface unit cell array 162 may be operatively coupled to a metasurface PMU 172 and the reflective properties may be controlled via a metasurface controller 187 that may be a field programmable gate array (FPGA) circuit microchip or other hardware controller at the reconfigurable metasurface unit cell array 162. Like the PMU 128 of the information handling system 100, the metasurface PMU 172 may include control from the reconfigurable metasurface MCU 166 to provide power to each of the addressable reconfigurable metasurface unit cells 164-1, 164-2 164-n. In an embodiment, the power needed to operate the reconfigurable metasurface unit cell array 162 may be low such that the metasurface battery 176 may be sufficient to change the properties of the addressable reconfigurable metasurface unit cells 164-1, 164-2 164-n in order to engage in the beamforming processes described herein.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

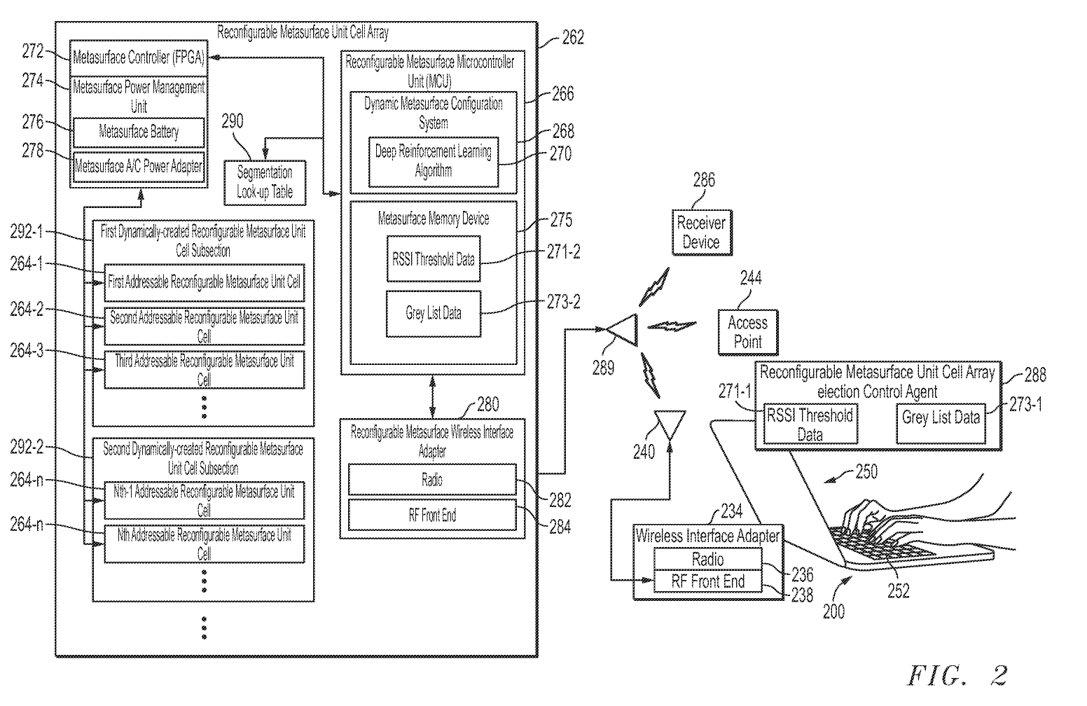

FIG. 2 is a block diagram illustrating a reconfigurable metasurface unit cell array executing machine readable code instructions of a dynamic metasurface configuration system to utilize RSSI threshold data and gray list data to dynamically allocate channels and partition the reconfigurable metasurface unit cell array for reflection of wireless transmissions to receiver information handling systems in a radiofrequency environment according to another embodiment of the present disclosure. FIG. 2 shows an information handling system 200 such as a laptop-type information handling system. In an embodiment, the information handling system 200 may include a keyboard 252 and digital display device 250 for a user such as an ITDM to execute, at the hardware processor, the reconfigurable metasurface unit cell array selection control agent 288 as described herein. A GUI may be presented to the user at the digital display device 250 for the user to receive output. The user may interface with the information handling system 200 to provide the optimization data, gray list data, device prioritization data, and RSSI threshold data as described herein.

As the user interfaces with the reconfigurable metasurface unit cell array selection control agent 288, the user may provide certain data that is relayed, via a side band communication channel, to the metasurface unit cell array 262. As described herein, this data may include RSSI threshold data 271-1 defining RSSI thresholds set by the user, device-specific optimization data, gray list data 273-1 including data describing network devices that may require targeted signal enhancement, device prioritization data, as well as other types of user-defined network data used to allocate channels within one or more frequency bands by the various devices operative coupled within the radiofrequency environment. This data may be stored on a metasurface memory device 275 and maintained as RSSI threshold data 271-2 and grey list data 273-2 that may be updated by the user with the information handling system 200 transmitting this data to the reconfigurable metasurface MCU 266 via operation of the wireless interface adapter 234 (e.g., with radio 236, RF front end 238, and antenna 240) and reconfigurable metasurface wireless interface adapter 280 (with radio 282, RF front end 284, and metasurface antenna 289) as described herein.

In addition to the data provided by the user (e.g., ITDM) from the information handling system 200, the reconfigurable metasurface MCU 266 may request or otherwise receive other real-time wireless network data from access points 244 in the radiofrequency environment that allows the reconfigurable metasurface MCU 266 to determine how to partition the plurality of addressable reconfigurable metasurface unit cells 264-1, 264-2, 264-3, 264-n-1, 264-n into individual segments or dynamically-created reconfigurable metasurface unit cell subsections 282-1, 292-2. For example, the access point 244 may transmit data describing current channel allocation for each of the wireless devices communicating within wireless networks in the radiofrequency environment using the access point 244. This data may also include available channels within a plurality of frequency bands that could reduce congestion within the wireless network and within the radiofrequency environment. Still further this real-time wireless network data may include data describing current channel congestion rates, current RSSI levels for each of the wireless communications, frequencies used within the wireless networks in the radiofrequency environment, among other real-time wireless network data.

As this real-time wireless network data and data from the user at the information handling system 200 is received, the reconfigurable metasurface MCU 266 may execute machine-readable code instructions of a dynamic metasurface configuration system 268 to define how to segment the addressable reconfigurable metasurface unit cells 264-1, 264-2, 264-3, 264-n-1, 264-n into individual dynamically-created reconfigurable metasurface unit cell subsections 282-1, 292-2. In an example embodiment, the dynamic metasurface configuration system 268 may include a deep reinforcement learning algorithm 270 that implements machine learning (ML) model techniques such as supervised learning, unsupervised learning, reinforcement learning, semi-supervised learning, and deep learning techniques, or combinations thereof. It is appreciated that although the deep reinforcement learning algorithm 270 is defined as a deep learning algorithm, the present specification contemplates that other types of ML techniques may be used to determine how the addressable reconfigurable metasurface unit cells 264-1, 264-2, 264-3, 264-n-1, 264-n are to be segmented and allocated into dynamically-created reconfigurable metasurface unit cell subsections 282-1, 292-2 across the reconfigurable metasurface unit cell array 262. Additionally, it is appreciated that, during execution of the dynamic metasurface configuration system 268 and its deep reinforcement learning algorithm 270, the deep reinforcement learning algorithm 270 may engage in retraining and/or training using a feedback loop that identifies any discrepancies between predicted and actual network performance thereby allowing for fine-tuning of the dynamic metasurface configuration system 268 and control algorithms such as the deep reinforcement learning algorithm 270.

The output from the dynamic metasurface configuration system 268 and its deep reinforcement learning algorithm 270 may be used by the reconfigurable metasurface MCU 266 to define how to segment the metasurface unit cell array 262 into one or more dynamically-created reconfigurable metasurface unit cell subsections 282-1, 292-2. In an embodiment, the reconfigurable metasurface MCU 266 may access a segmentation look-up table 290 to define how the dynamically-created reconfigurable metasurface unit cell subsections 282-1, 292-2 are to be addressed and reconfigurable resonant structures adjusted for a plurality of addressable reconfigurable metasurface unit cells 264-1, 264-2, 264-3, 264-n-1, 264-n. For example, the output from the dynamic metasurface configuration system 268 may define that, a specifically identified wireless transmission at a specified frequency from a network device that has a certain level of priority may require a defined number of addressable reconfigurable metasurface unit cells 264-1, 264-2, 264-3, 264-n-1, 264-n devoted to a single dynamically-created reconfigurable metasurface unit cell subsection 282-1 or 292-2 so that the transmission may be redirected from off of the surface of the metasurface unit cell array 262 in a specific direction using beamforming techniques (e.g., constructive interference and/or destructive interference) to achieve a particular gain in RSSI level. The reconfigurable metasurface MCU 266 may then, with the information from the segmentation look-up table 290, create a subsection of addressable reconfigurable metasurface unit cells 264-1, 264-2, 264-3, 264-n-1, 264-n within the reconfigurable metasurface unit cell array 262 to beamform the plurality of wireless transmissions and increase the RSSI levels of the plurality of wireless transmissions of a plurality of wireless information handling systems operatively coupled to the wireless network.

As shown in FIG. 2, two example dynamically-created reconfigurable metasurface unit cell subsections 282-1, 292-2 are shown. A first dynamically-created reconfigurable metasurface unit cell subsection 292-1 includes at least a first addressable reconfigurable metasurface unit cell 264-1, a second addressable reconfigurable metasurface unit cell 264-2, and a third addressable reconfigurable metasurface unit cell 264-3. Again, this is merely an example of a dynamically-created reconfigurable metasurface unit cell subsections 282-1, 292-2 and the first dynamically-created reconfigurable metasurface unit cell subsection 292-1 may include more or fewer of the addressable reconfigurable metasurface unit cells 264-1, 264-2, 264-3 shown in FIG. 2. As another example, the second dynamically-created reconfigurable metasurface unit cell subsection 292-2 may include an nth-1 addressable reconfigurable metasurface unit cell 264-n-1 and an nth addressable reconfigurable metasurface unit cell 264-n. Similar to the first dynamically-created reconfigurable metasurface unit cell subsection 292-1, the second dynamically-created reconfigurable metasurface unit cell subsection 292-2 may include more or fewer than the nth-1 addressable reconfigurable metasurface unit cell 264-n-1 and nth addressable reconfigurable metasurface unit cell 264-n shown.

Thus, the presently-described reconfigurable metasurface unit cell array 262 of embodiments herein leverages the dynamic metasurface configuration system 268 and deep reinforcement learning algorithm 270 to dynamically manage the slicing, partitioning, and segmentation configuration of reconfiguration metasurface unit cell array 262 for reflection of each of the plurality of wireless transmissions of allocated channels with a plurality of wireless information handling systems 200 within radiofrequency environment of the wireless network.

In an embodiment, the architecture of the reconfigurable metasurface unit cell array 262 includes a reconfigurable metasurface MCU 266 that interfaces with the access point 244 or base station to receive real-time network data, such as user information handling system density within the wireless network, signal quality, as well as other network characteristics and environmental factors of a radiofrequency environment. With this data, the dynamic metasurface configuration system 268 with deep reinforcement learning algorithm 270 may be trained to predict the optimal configuration of addressable reconfigurable metasurface unit cells 264-1 to 264-n into subsections 292-1, 292-2 or others of the reconfigurable metasurface unit cell array 262. Output of the execution of machine readable code instructions of the dynamic metasurface configuration system 268 may be used to instruct the reconfigurable metasurface MCU 266 to adjust the reflection and transmission properties of addressable reconfigurable metasurface unit cells 264-1 to 264-n in the reconfigurable metasurface unit cell array 262 to beamsteer wireless signals and allocate channels effectively within the designated subsections 292-1, 292-2 in embodiments of the present disclosure. By continuously learning from the environment and network data, the dynamic metasurface configuration system can adapt to changing conditions, such as user movement or varying interference levels, and make real-time adjustments to subsections 292-1, 292-2 to maximize network performance. This allows the reconfigurable metasurface MCU 266 to address individual and specific addressable reconfigurable metasurface unit cells 264-1 to 264-n within the metasurface unit cell array 262 in order to increase RSSI values for any of the plurality of wireless transmissions and allocated channels for those wireless transmissions. It is appreciated that as the number of reconfigurable metasurface unit cells 264-1, 264-2, 264-n are included within a specific dynamically-created reconfigurable metasurface unit cell subsection 292-1, 292-2 increases, the RSSI levels may increase. Indeed, as more reconfigurable metasurface unit cells 264-1, 264-2, 264-n are included within a specific dynamically-created reconfigurable metasurface unit cell subsection 292-1, 292-2 the gain of the reflected EM waves of the wireless transmission may be increased from that subsection 292-1, 292-2 to allow for better beamforming of the reflected EM waves.

The systems and methods described herein may also incorporate a feedback loop where the system's performance is monitored, and the dynamic metasurface configuration system 268 is updated to refine its decision-making process. The system’s performance is reported via sideband channels back to the reconfigurable metasurface unit cell array 262 and the reconfigurable metasurface MCU 268 for feedback to train the deep reinforcement learning algorithm 270 of the dynamic metasurface configuration system 268 such that further adjustments to allocation of reconfigurable metasurface unit cells 264-1 to 264-n may be made for the specific dynamically-created reconfigurable metasurface unit cell subsections 292-1, 292-2 according to embodiments herein. This system and method may enhance spectrum efficiency, reduces interference, and ensures consistent QoS with use of the reconfigurable metasurface unit cell array 262 thereby offering a scalable and flexible framework for wireless networks in a radiofrequency environment.

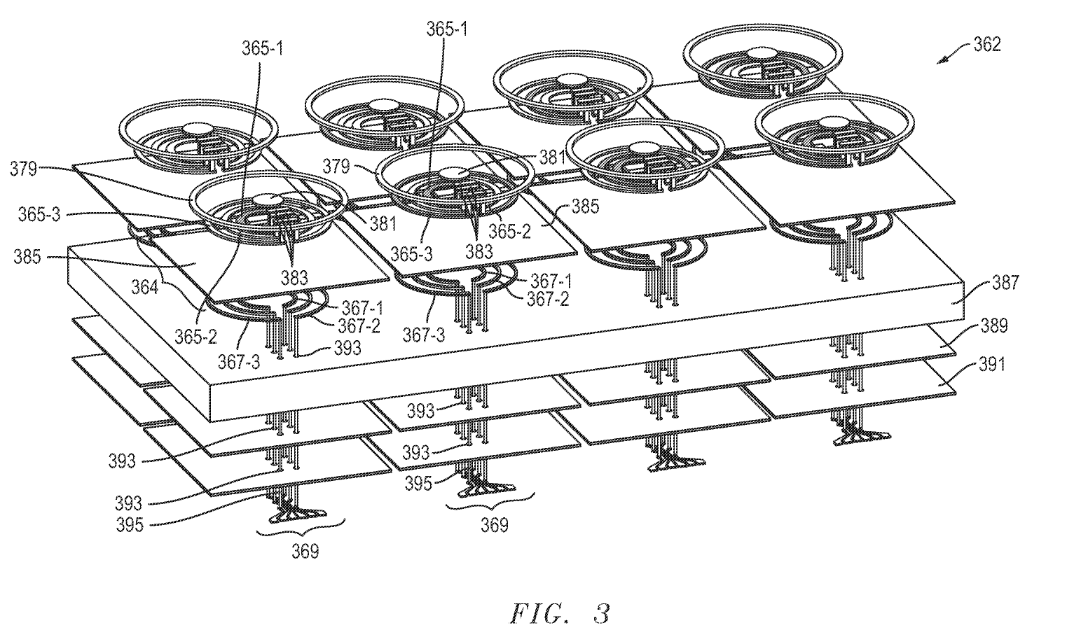

FIG. 3 is a graphic diagram showing an exploded perspective view of, at least, a portion of reconfigurable metasurface unit cell array 362 according to an embodiment of the present disclosure. In this example, FIG. 3 is a perspective view exploded graphic diagram illustrating a plurality of unit cells 364 of a reconfigurable metasurface unit cell array 362 according to one embodiment of the present disclosure. The reconfigurable metasurface unit cells 364 of FIG. 3 are one type of unit cell with reconfigurable capacitance for the reconfigurable metasurface unit cell array 362 that may be used with embodiments herein. FIG. 3 illustrates one embodiment used to predict the optimal configuration of subsections of the reconfigurable metasurface unit cell array 362 and instruct the reconfigurable metasurface MCU how to adjust the reflection and transmission properties of the reconfigurable metasurface unit cell array 362 to beamsteer wireless signals and allocate channels effectively with specific dynamically-created reconfigurable metasurface unit cell subsections for those allocated channels.

As shown in FIG. 3, each reconfigurable metasurface unit cell 364 may include a stacking of various element layers including a substrate layer 387, a resonant structure layer having plural resonant structures including reconfigurable resonant structures, and a metal backing layer or metallization layer 389. It is appreciated that each of the reconfigurable metasurface unit cells 364 of the reconfigurable metasurface unit cell array 362 may comprise their own various layers or may, in an embodiment, share the same layer or layers within the array. Again, the reconfigurable metasurface unit cell 364 shown in FIG. 3 may one of a plurality of unit cells 364 that form the reconfigurable metasurface unit cell array 362 and may include any number of unit cells 364 arranged in any manner on a two-dimensional plane to form a reconfigurable metasurface unit cell array 362 or subsections thereof. In an embodiment, the reconfigurable metasurface unit cell array 362 may be an array of sixteen addressable reconfigurable metasurface unit cells 364 by sixteen addressable reconfigurable metasurface unit cells 364. It is also appreciated that although FIG. 3 shows the various elements of the plurality of addressable reconfigurable metasurface unit cells 364, for purposes of discussion the bottom-left two addressable reconfigurable metasurface unit cells 364 are discussed, however, the other unit cells 364 depicted in FIG. 3 include similar elements and operation.

As shown in FIG. 3, the addressable reconfigurable metasurface unit cells 364 include concentrically formed first metasurface reconfigurable split ring 365-1, second metasurface reconfigurable split ring 365-2, and third metasurface reconfigurable split ring 365-3 on a first resonant structure layer of the addressable reconfigurable metasurface unit cell 364 and disposed over a first dielectric layer 385 and a main dielectric substrate layer 387. Each of these metasurface reconfigurable split rings 365-1, 365-2, 365-3 are reconfigurable in that they may include any phase change materials such as GeTe, SbTe, or GeSbTe among other similar non-volatile phase change materials to transition between a dielectric state and a conductive state. The metasurface reconfigurable split rings 365-1, 365-2, 365-3 share the same layer as the non-reconfigurable metal fixed ring 379 and non-reconfigurable metal fixed center node 381 and act together as plural resonant structures to focus (e.g., increase or decrease the feed distance) the directionality (e.g., beam steering) of the EM wave beams reflected off of the addressable reconfigurable metasurface unit cell array 362 as described in embodiments herein. In an embodiment, the non-reconfigurable metal fixed ring 379 and non-reconfigurable metal fixed center node 381 may be made of a metal such as Au, Cu, Al, Ni among other types of conductive metals. It is appreciated that the metasurface reconfigurable rings 365-1, 365-2, 365-3, the non-reconfigurable metal fixed ring 379, and the non-reconfigurable metal fixed center node 381 may be formed onto the same layer and may be referred to herein as a first resonant structure layer of any given addressable reconfigurable metasurface unit cell 364.

In an embodiment, each of the metasurface reconfigurable split rings 365-1, 365-2, 365-3 may include a split or gap along the circumference of the metasurface reconfigurable split rings 365-1, 365-2, 365-3. As shown in FIG. 3, for example, this gap correlates with a gap in each of the respective refractory heaters 367-1, 367-2, 367-3 formed below the first dielectric layer 385 and within a main substrate layer 387 so the refractory heaters 367-1, 367-2, 367-3 may operate to heat the metasurface reconfigurable split rings 365-1, 365-2, 365-3 to change their state. In order, however, to complete a conductive ring structure when phase change material is in a conductive state of each of the metasurface reconfigurable split rings 365-1, 365-2, 365-3, this gap in each metasurface reconfigurable split rings 365-1, 365-2, 365-3 may be bridged using a conductive bridge 383. The conductive bridge 383 allows for induced currents in each of the metasurface reconfigurable split rings 365-1, 365-2, 365-3 to create radiated fields that form the reflected wave patterns described in embodiments herein.

Below this first resonant structure layer comprised of the metasurface reconfigurable split rings 365-1, 365-2, 365-3, the non-reconfigurable metal fixed ring 379, and the non-reconfigurable metal fixed center node 381, the reconfigurable metasurface unit cell 364 includes the first dielectric layer 385 to isolate the respective refractory heaters 367-1, 367-2, 367-3. This first dielectric layer 385 may be made of SiNx of AlN. In an embodiment, this first dielectric layer 385 may include any insulating substance that does not conduct electricity but may also support electrostatic fields created during operation of the reconfigurable metasurface unit cell 364. This first dielectric layer 385 may still be thermally conductive however in embodiments herein. In an embodiment, the first dielectric layer 385 may be shared among all unit cells 364 within the reconfigurable metasurface unit cell array 362. In another embodiment shown in FIG. 3, each reconfigurable metasurface unit cell 364 has its own dedicated first dielectric layer 385.

Below the first dielectric layer 385, a second layer may be formed that comprise the first refractory heater 367-1, the second refractory heater 367-2, and the third refractory heater 367-3 within or on top of a main dielectric substrate layer 387. The refractory heaters 367-1, 367-2, 367-3 may each, individually and selectively, heat their respective metasurface reconfigurable split ring 365-1, 365-2, 365-3. Thus, when a power pulse from a power source addressable at contact pads 369 is applied to the first refractory heater 367-1, the first refractory heater 367-1 heats the first metasurface reconfigurable split ring 365-1. Additionally, when the addressable power pulse from a power source is applied to contact pads 369 of the second refractory heater 367-2, the second refractory heater 367-2 heats the second metasurface reconfigurable split ring 365-2. Further, when a power pulse from a power source is applied to contact pads 369 of the third refractory heater 367-3, the third refractory heater 367-3 heats the third metasurface reconfigurable split ring 365-3. Thus, the states of each of the metasurface reconfigurable split rings 365-1, 365-2, 365-3 may be individual controlled via pulsed heating of the individual refractory heaters 367-1, 367-2, 367-3 such that the states of the metasurface reconfigurable split rings 365-1, 365-2, 365-3 may be switched from their amorphous states to their crystalline states or vice versa. This pulsed power can therefore toggle between a dielectric state and a conductive state respectively for each of the metasurface reconfigurable split rings 365-1, 365-2, 365-3 for the addressable reconfigurable metasurface unit cell 364. It is appreciated that the number of refractory heaters 367-1, 367-2, 367-3 shown in FIG. 3 is merely an example number of refractory heaters 367-1, 367-2, 367-3 and where the number of metasurface reconfigurable rings 365-1, 365-2, 365-3 differs from the three shown, a commensurate number of refractory heaters 367-1, 367-2, 367-3 may also be used to accommodate for the extra number of metasurface reconfigurable rings 365-1, 365-2, 365-3 for the addressable reconfigurable metasurface unit cell 364. Additionally, where the number of refractory heaters 367-1, 367-2, 367-3 increases beyond the three shown in FIG. 3, a commensurate number of contact pads 369, metal interconnect layers 395, and vias 393 are also increased to accommodate for the application of the power pulses to the additional refractory heaters 367-1, 367-2, 367-3.

It is appreciated that the voltage and current applied to each of the refractory heaters 367-1, 367-2, 367-3 controls the states of the metasurface reconfigurable split rings 365-1, 365-2, 365-3. For example, where the voltage applied to any of the refractory heaters 367-1, 367-2, 367-3 is high (e.g., 15-20 V) for a short period of time (e.g., up to 0.5 microseconds (µs)) with a peak current of 300 to 310 mA, the metasurface reconfigurable split rings 365-1, 365-2, 365-3 are transitioned to an amorphous state. This application of this voltage at this current, for example, creates a peak temperature at a metasurface reconfigurable split ring 365-1, 365-2, 365-3 of 700 to 800° C in order to transition from the crystalline state to this amorphous state in this example. However, where the voltage applied to any of the refractory heaters 367-1, 367-2, 367-3 is relatively lower (e.g., 9-10 V) for a relatively longer period of time (e.g., 2 µs) with a peak current of 210 to 220 mA the metasurface reconfigurable split rings 365-1, 365-2, 365-3 are transitioned to a crystalline state. This application of this voltage at this current creates, in an example embodiment, a peak temperature at a metasurface reconfigurable split ring 365-1, 365-2, 365-3 of 400 to 410° C in order to transition from the amorphous state to this crystalline state in this example. It is appreciated that in order to place the non-volatile phase change material of the metasurface reconfigurable split rings 365-1, 365-2, 365-3 into an amorphous state or a crystalline state depends on the type of non-volatile phase change material used. Thus, the electrical pulse from the metasurface PMU (e.g., FIG. 1, 172) at an applied voltage and current to each of the refractory heaters 367-1, 367-2, 367-3 to change the state of the non-volatile phase change material of each metasurface reconfigurable split ring 365-1, 365-2, 365-3 may depend on the type of non-volatile phase change material used and the present specification contemplates that other non-volatile phase change materials may be used necessitating changes in these applied voltages and currents.

Other layers and substrates may also be included in the stack within the addressable reconfigurable metasurface unit cell 364. In an example embodiment, the reconfigurable metasurface unit cell 364 may further include an electrical dielectric substrate 387 placed below the second layer that comprises the refractory heaters 367-1, 367-2, 367-3. This electrical dielectric substrate 387 may be made of a HRSI, Al₂O₃, glass, or PCB among other dielectric materials. In an embodiment, the first dielectric layer 385 and electrical dielectric substrate 387 may electrically isolate the refractory heaters 367-1, 367-2, 367-3 from the remaining portions of the addressable reconfigurable metasurface unit cell 364. Again, it is appreciated that each of the addressable reconfigurable metasurface unit cells 364 of the reconfigurable metasurface unit cell array 362 may share the same layer of electrical dielectric substrate 387 as shown in FIG. 3. However, the present specification also contemplates that each reconfigurable metasurface unit cell 364 may have their own layer of electrical dielectric substrate 387 disconnected from the electrical dielectric substrates 387 of the other unit cells 364.

In an embodiment, a metallization layer 389 may be formed below the electrical dielectric substrate 387. This metallization layer 389 may be made of Au, Cu, Al, or Ni among other types of metals. In an embodiment, this metallization layer 389 may serve as an RF grounding source for the addressable reconfigurable metasurface unit cell 364 and assist with reflection of incoming EM waves. Again, it is appreciated that each of the addressable reconfigurable metasurface unit cells 364 of the reconfigurable metasurface unit cell array 362 may share the same layer of metallization layer 389. However, the present specification also contemplates that each addressable reconfigurable metasurface unit cell 364 may have their own layer of metallization layer 389 disconnected from the metallization layer 389 of the other addressable unit cells 364 as shown in FIG. 3.

In an embodiment, a second dielectric layer 391 may be placed below the metallization layer 389. This second dielectric layer 391 may be made of silicon dioxide (SiO₂). Similar to the first dielectric layer 385, the second dielectric layer 391 may also support electrostatic fields created during the operation of the addressable reconfigurable metasurface unit cell 364. Again, it is appreciated that each of the addressable reconfigurable metasurface unit cells 364 of the reconfigurable metasurface unit cell array 362 may share the same layer of second dielectric layer 392. However, the present specification also contemplates that each addressable reconfigurable metasurface unit cell 364 may have their own layer of second dielectric layer 391 disconnected from the second dielectric layers 391 of the other unit cells 364 as shown in FIG. 3.

Below the second dielectric layer 391, the contact pads 369 used to electrically couple the refractory heaters 367-1, 367-2, 367-3 to a metasurface PMU (e.g., FIG. 2, 274) are shown. The contact pads 369 may be made of any conductive metal such as Au, Cu, Al, or Ni among other types of metals. The contact pads 369 may receive those electrical voltage pulses from the metasurface PMU in order to heat, individually, each of the refractory heaters 367-1, 367-2, 367-3. In order to operatively couple each of the refractory heaters 367-1, 367-2, 367-3 to a respective contact pad 369, a plurality of metal interconnect layers 395 are formed. In the example embodiment shown in FIG. 3, the metal interconnect layers 395 couple a contact pad 369 to each terminal end of each of the refractory heaters 367-1, 367-2, 367-3. In order to do so, one or more vias 393 are formed through, at least, the second dielectric layer 391, the metallization layer 389, and the electrical dielectric substrate 387 so that the metal interconnect layers 395 may pass from each of the respective contact pads 369 to their respective refractory heaters 367-1, 367-2, 367-3.

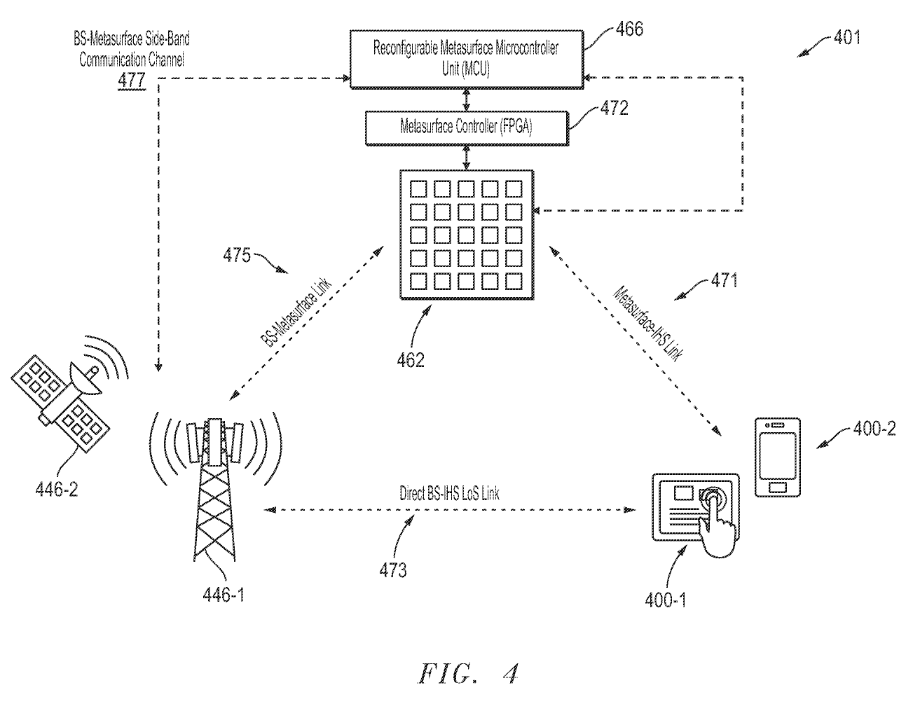

FIG. 4 is a graphic and block diagram of one or more wireless networks in a radiofrequency environment 401 that includes a reconfigurable metasurface unit cell array 462, an access point 466-1 or base station 466-2, and a plurality of information handling systems 400-1, 400-2 according to an embodiment of the present disclosure. FIG. 4 shows an example interaction and data transmissions between the reconfigurable metasurface unit cell array 462, a plurality of information handling systems 400-1, 4002, and one or more base stations 446-1, 446-2 or other transmitting device via wireless networks within the radiofrequency environment 401.

As described herein, the user may interact with one or more information handling systems 400-1, 400-2 in order to provide certain data to the reconfigurable metasurface unit cell array 462. Again, this data may include RSSI threshold level data, device-specific optimization data, gray list data, and device prioritization data. This data may be transmitted to the reconfigurable metasurface unit cell array 462 via a metasurface-information handling system link 471. In an embodiment, this metasurface-information handling system link 471 may be a side-band communication channel that includes either an out-of-band (OOB) communication channel that uses a separate frequency band from a main communication channel (e.g., 2.4 GHz or 5 GHz) or an in-band communication channel that uses the same frequency bands as those used by the information handling systems 400-1, 400-2 and/or base stations 446-1, 446-2 or other network device in a wireless network. The addressable reconfigurable metasurface unit cell array 462 reflects EM waves to form base station-metasurface link 475 and the metasurface-information handling system link 471 that may be used by the information handling systems 400-1, 400-2 to relay information from the information handling systems 400-1, 400-2 to the base stations 446-1, 446-2 and vice-versa with the reconfigurable metasurface unit cell array 462 reflecting EM waves off of its surface and towards the base stations 446-1, 446-2 or other information handling systems 400-1, 400-2 and vice-versa to the base station 446-1, 446-2 or an access point.

In some embodiments, the information handling systems 400-1, 400-2 may be placed at a location within the radiofrequency environment where there is a direct line-of-sight (LoS) wireless link 473 with one or more of the base stations 446-1, 446-2. This allows the information handling systems 400-1, 400-2, in an embodiment, to directly communicate with the base stations 446-1, 446-2 using a direct base station-information handling system LoS link 473 for exchange of wireless network and radiofrequency environment conditions without the use of the reconfigurable metasurface unit cell array 462 to reflect EM waves from the information handling systems 400-1, 400-2 to the base stations 446-1, 446-2. However, this direct line-of-sight (LoS) wireless link 473 may be of limited RSSI level and not permit higher QoS wireless links as may be provided by reflecting EM waves from the information handling systems 400-1, 400-2 to the base stations 446-1, 446-2 with the reconfigurable metasurface unit cell array 462 in embodiments herein.

Additionally, the base stations 446-1, 446-2 may similarly use the reconfigurable metasurface MCU 466 to relay transmissions via the reconfigurable metasurface unit cell array 462. Again, the reconfigurable metasurface unit cell array 462 may reflect one or more EM waves at one or more frequencies and channels to one or more information handling systems 400-1, 400-2. This may be done via the base station-metasurface link 475 as shown in FIG. 4 in an embodiment and reflected via the metasurface-information handling system link 471. Still further, the base stations 446-1, 446-2 may wirelessly communicate with the reconfigurable metasurface unit cell array 462 via a base station-metasurface side-band communication channel 477. This base station-metasurface side-band communication channel 477 that may be used to, in an embodiment, transmit the real-time wireless network data such as the current RSSI levels, new or returning network devices within the wireless network, current channel allocations within the wireless network, and other wireless network data as described herein.

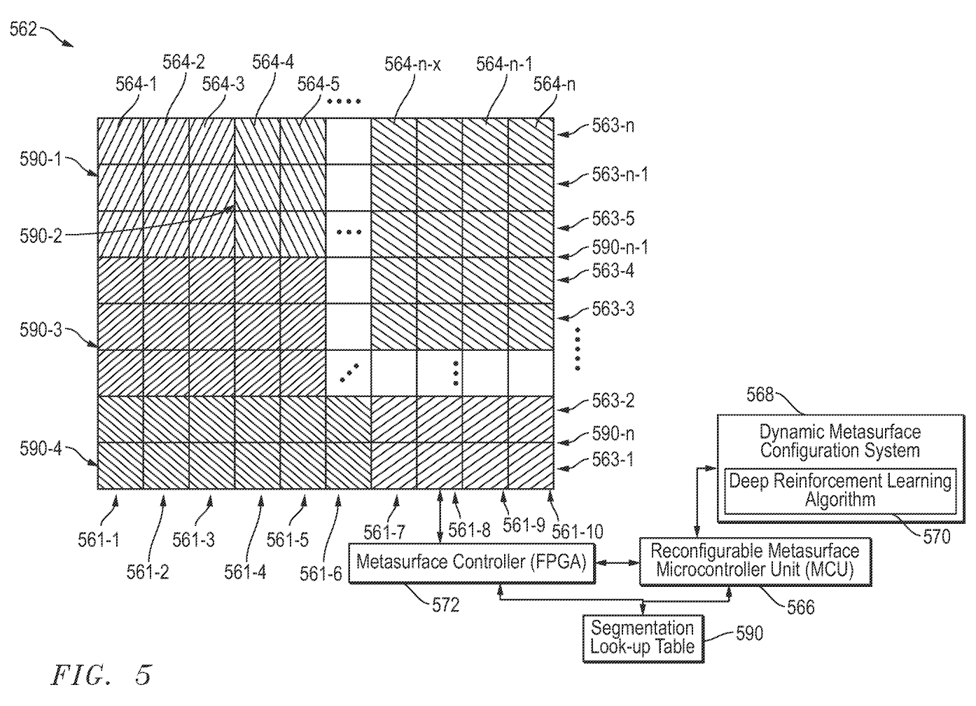

FIG. 5 is a block diagram of an addressable reconfigurable metasurface unit cell array 562 segmented into a plurality of subsections 590-1, 590-2, 590-3, 590-4, 590-n-1, 590-n via operation of a metasurface controller and reconfigurable metasurface microcontroller unit (MCU) according to an embodiment of the present disclosure. As described herein, the reconfigurable metasurface MCU 566 receives the RSSI threshold data, the gray list data, and the device prioritization data from the information handling system executing the reconfigurable metasurface unit cell array selection control agent as described herein. Additionally, the reconfigurable metasurface MCU 566 may also receive the real-time wireless network data via a reconfigurable metasurface wireless adapter from the base stations or other network devices that may include current RSSI levels, current channel congestion rates, new and current number of wireless network devices, and other real-time wireless network data of a radiofrequency environment.

As this real-time wireless network data and data from the user at the information handling system is received, the reconfigurable metasurface MCU 566 may execute machine readable program code of a dynamic metasurface configuration system 568 to define how to segment the columns and rows of addressable reconfigurable metasurface unit cells 564-1 through 564-n into individual dynamically-created reconfigurable metasurface unit cell subsections 590-1, 590-2, 590-3, 590-4, 590-n-1, 590-n. In an example embodiment, the dynamic metasurface configuration system 568 may include a deep reinforcement learning algorithm 570 that implements ML model techniques such as supervised learning, unsupervised learning, reinforcement learning, semi-supervised learning, and deep learning techniques, or combinations thereof. It is appreciated that although the deep reinforcement learning algorithm 570 is defined as a deep learning algorithm, the present specification contemplates that other types of ML techniques may be used to define how the columns and rows of the addressable reconfigurable metasurface unit cells 564-1 through 564-n are to be segmented into dynamically-created reconfigurable metasurface unit cell subsections 590-1, 590-2, 590-3, 590-4, 590-n-1, 590-n.

FIG. 5 shows that, pursuant to the output from the dynamic metasurface configuration system 568 and its deep reinforcement learning algorithm 570, the reconfigurable metasurface MCU 566 may access, for example, a segmentation look-up table 590. In an embodiment, upon processing and receiving the current RSSI levels, current channel congestion rates, new and current number of wireless network devices, and other real-time wireless network data as well as the RSSI threshold data, the gray list data, and the device prioritization data for the radiofrequency environment, the reconfigurable metasurface MCU 566 executes machine readable code instructions of the dynamic metasurface configuration system 568 to determine adjustments needed to RSSI levels for particular wireless transmissions on allocated channels in embodiments herein. Further, execution of machine readable code instructions of the dynamic metasurface configuration system 568 to associate those RSSI adjustment requirements with reflected lobe adjustments and size adjustments needed or available to the plural dynamically-created reconfigurable metasurface unit cell subsections 590-1, 590-2, 590-3, 590-4, 590-n-1, 590-n to adjust gain of reflected wireless transmissions accordingly. In embodiments herein, the execution of machine readable code instructions of the dynamic metasurface configuration system 568 by the reconfigurable metasurface MCU 566 may access a segmentation look-up table 590 that may be used to define how the dynamically-created reconfigurable metasurface unit cell subsections 590-1, 590-2, 590-3, 590-4, 590-n-1, 590-n are currently arranged and how they are to be adjusted to add or subtract all or portions of columns (i.e., 561-1 through 561-n) of the addressable reconfigurable metasurface unit cells 564-1 through 564-n or rows (i.e., 563-1 through 563-n) of the addressable reconfigurable metasurface unit cells 564-1 through 564-n from each adjacent dynamically-created reconfigurable metasurface unit cell subsections 590-1, 590-2, 590-3, 590-4, 590-n-1, 590-n to those rows or columns.

It is appreciated that the output from the execution of machine readable code instructions of the dynamic metasurface configuration system 568 and its deep reinforcement learning algorithm 570 may identify a suggested number of addressable reconfigurable metasurface unit cells 564-1 through 564-n from adjacent columns 561-1 through 561-n or rows 563-1 through 563-n to use in order to dynamically add to or subtract addressable reconfigurable metasurface unit cells from one or more adjacent reconfigurable metasurface unit cell subsections 590-1, 590-2, 590-3, 590-4, 590-n-1, 590-n in embodiments herein. The segmentation look-up table 590 may identify a specific block within the reconfigurable metasurface unit cell array 562 are currently established as reconfigurable metasurface unit cell subsections 590-1, 590-2, 590-3, 590-4, 590-n-1, 590-n and those adjacent columns 561-1 through 561-n or rows 563-1 through 563-n available for readjustment to expand or contract sizes of various reconfigurable metasurface unit cell subsections 590-1, 590-2, 590-3, 590-4, 590-n-1, 590-n depending on RSSI gain adjustment needs of particular allocated channels of reflected wireless transmission. In an embodiment, because the reconfigurable metasurface unit cell subsections 590-1, 590-2, 590-3, 590-4, 590-n-1, 590-n are dynamically created based on real-time network data and may be changed from time to time, the segmentation look-up table 590 may by used by the reconfigurable metasurface MCU 566 to identify those current groupings of reconfigurable metasurface unit cells 564-1 through 564-n in columns 561-1 through 561-n and rows 563-1 through 563-n that are used to create the reconfigurable metasurface unit cell subsections 590-1, 590-2, 590-3, 590-4, 590-n-1, 590-n as well as adjacent columns 561-1 through 561-n and rows 563-1 through 563-n of addressable reconfigurable metasurface unit cells 564-1 through 564-n that may be adjusted to add to or subtract from particular reconfigurable metasurface unit cell subsections 590-1, 590-2, 590-3, 590-4, 590-n-1, 590-n.

Once the appropriate set of addressable reconfigurable metasurface unit cells 564-1 through 564-n from columns 561-1 through 561-n and rows 563-1 through 563-n are identified by the reconfigurable metasurface MCU 566 that would satisfy the allocation to the one or more reconfigurable metasurface unit cell subsections 590-1, 590-2, 590-3, 590-4, 590-n-1, 590-n, the reconfigurable metasurface MCU 566 addresses the metasurface controller 572 with instructions related to how to reconfigure the addressable reconfigurable metasurface unit cell array 562. In an embodiment, these instructions from the reconfigurable metasurface MCU 566 to the metasurface controller 572 may include which specific addressable reconfigurable metasurface unit cells 564-1 through 564-n from columns 561-1 through 561-n and rows 563-1 through 563-n for the metasurface controller 572 to address and how they are supposed to be reconfigured. These instructions may include data describing location of each specific addressable reconfigurable metasurface unit cells 564-1 through 564-n from columns 561-1 through 561-n and rows 563-1 through 563-n described in terms of a specific column of unit cells 561-1 through 561-10 and row of unit cells 563-1 through 563-n to address. In an embodiment, the metasurface controller 572 may be a field-programmable gate array (FPGA) that can address a specific row 563-1 through 563-n of addressable reconfigurable metasurface unit cells 564-1 through 564-n and a specific column 561-1 through 561-10 of addressable reconfigurable metasurface unit cells 564-1 through 564-n in order to address each specific addressable reconfigurable metasurface unit cells 564-1 through 564-n to reconfigure them to properly allocate them in reconfigurable metasurface unit cell subsections 590-1, 590-2, 590-3, 590-4, 590-n-1, 590-n to reflect specific EM waves at specific frequencies of allocated channels of wireless transmission in the radiofrequency environment.

In an embodiment, the reconfigurable metasurface MCU 566 also receives output from the execution of the dynamic metasurface configuration system 568 and its deep reinforcement learning algorithm 570 that provides additional data to the plurality of access points. This data may include data describing congestion within a given channel within a frequency bands and suggestions to the access point as to how to assign or allocate unused channels within a band in order to reduce this congestion. In an embodiment, the reconfigurable metasurface MCU 566 and metasurface controller 572 may create a reconfigurable metasurface unit cell subsection 590-1, 590-2, 590-3, 590-4, 590-n-1, 590-n to be used by an allocated channel of a wireless transmission recommended by the reconfigurable metasurface MCU 566 to the access points. Thus, in an embodiment, the reconfigurable metasurface MCU 566 may control the channel allocation of any of a plurality of access points so that any frequency band is selected to be less congested by dynamic channel allocation by the reconfigurable metasurface MCU 566 and reflected by the dynamically reconfigurable metasurface unit cell subsection 590-1, 590-2, 590-3, 590-4, 590-n-1, 590-n of the addressable reconfigurable metasurface unit cell array 562. Thus, although the access points may initially determine channel allocation among the various wireless network devices, the reconfigurable metasurface MCU 566 may provide instructions as to how to reallocate those channels within any given frequency band of a wireless transmission among plural wireless transmission in a radiofrequency environment in order to mitigate wireless congestion within the wireless networks of the radiofrequency environment in embodiments herein.

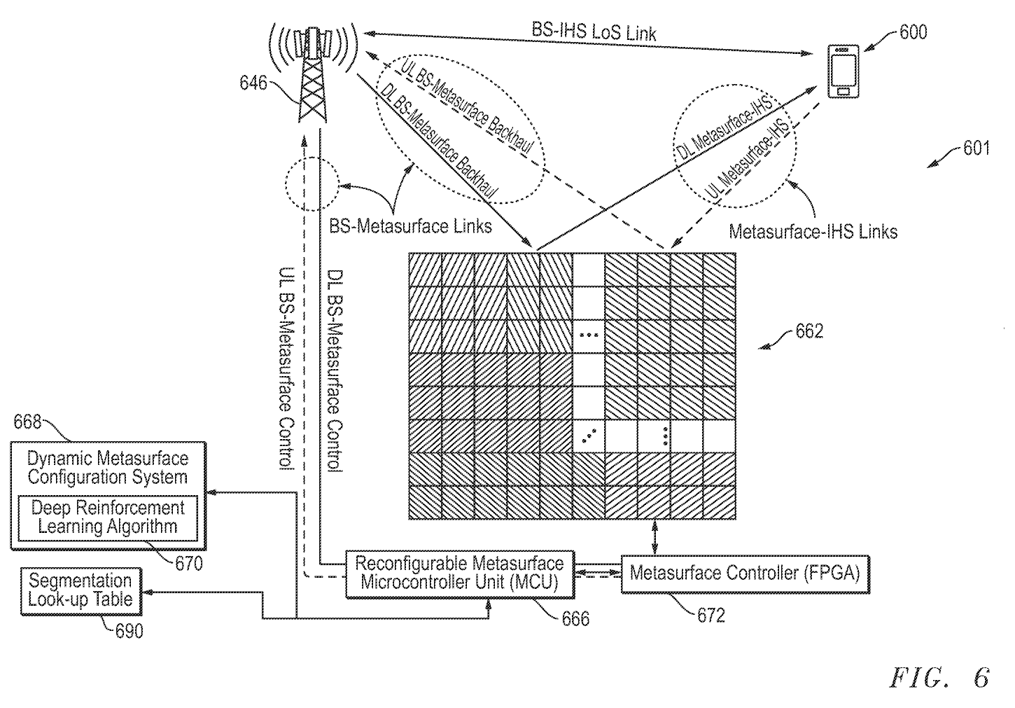

FIG. 6 is a graphic and block diagram of a radiofrequency environment 601 with a reconfigurable metasurface unit cell array 662 segregated into a plurality of subsections via operation of a metasurface controller (FPGA) 672 and reconfigurable metasurface MCU 666 and operatively and wirelessly coupled to an access point 646 via a sideband communication channel according to an embodiment of the present disclosure. It is appreciated that the reconfigurable metasurface unit cell array 662 shown in FIG. 6 may be similar to that described in FIG. 5 with the reconfigurable metasurface MCU 666 and metasurface controller 672 given the ability to dynamically create a plurality of reconfigurable metasurface unit cell subsections based on execution of machine readable code instructions of the dynamic metasurface configuration system 668 with deep reinforcement learning algorithm 670 and a segmentation look-up table 690 according to embodiments herein. Execution of machine readable code instructions of the dynamic metasurface configuration system 668 with deep reinforcement learning algorithm 670 by the reconfigurable metasurface MCU 666 may adjust addressable reconfigurable metasurface unit cells into subsections of the reconfigurable metasurface unit cell array 662 based on the data received from the information handling system 600, the data received from the access point 646, and the currently detected real-time wireless network characteristics within the wireless networks in the radiofrequency environment 601.

Again, the reconfigurable metasurface MCU 666 may establish a side band communication channel with the base station or access point 646, via a reconfigurable metasurface antenna and radio of a metasurface wireless adapter, to report data that includes the beamformed plurality of wireless transmissions, suggested channel allocation at the base station or access point 646, and receive that wireless network data from the base station or access point 646. This includes both download (DL) base station-metasurface control data and upload (UL) base station-metasurface control data. Additionally, in some embodiments, the base station or access point 646 may have a LoS link with the information handling system 600 as described in connection with FIG. 4. Even further, where there is no LoS between the access point and information handling system 600, the reconfigurable metasurface unit cell array 662 may be used for both uploading and downloading data to and from the information handling system 600. In an embodiment, the base station or access point 646 may create a DL and UL base station-metasurface backhaul link with the information handling system 600 to download data from the base station or access point 646 as well as for the base station or access point 646 to upload data from the information handling system 600. Additionally, the information handling system 600 may establish an upload and download metasurface-information handling system link for the information handling system 600 to upload data to and download data from the reconfigurable metasurface unit cell array 662.

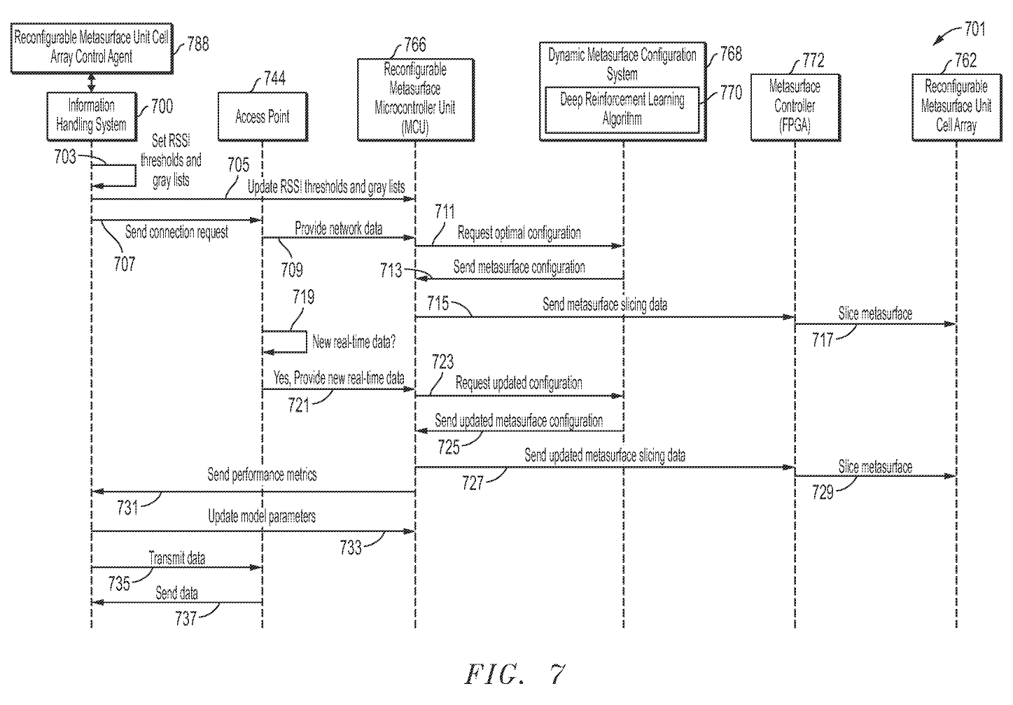

FIG. 7 is a swimlane process flow diagram for a method 700 of allocating wireless channels using an addressable reconfigurable metasurface unit cell array 762 according to an embodiment of the present disclosure. The method 701 described in connection with FIG. 7 may be implemented on any of the information handling systems 700 and reconfigurable metasurface unit cell arrays 762 described in connection with, for example, FIGS. 3-6.

At line 703, the method 701 may include setting RSSI thresholds and gray lists by the user. As described herein, this may be done by the user interfacing with the reconfigurable metasurface unit cell array selection control agent 788 at an information handling system 700. With the execution of machine-readable program code instructions of the reconfigurable metasurface unit cell array selection control agent 788, the user may provide certain data that is relayed, via a side band communication channel, to the reconfigurable metasurface MCU 766 of the metasurface unit cell array 762. As described herein, this data may include RSSI threshold data defining RSSI thresholds set by the user, device-specific optimization data, gray list data including data describing network devices in a radiofrequency environment that may require targeted signal enhancement, device prioritization data, as well as other types of user-defined network data used to allocate channels within one or more frequency bands by the various devices in the wireless network with wireless transmissions being reflected by the metasurface unit cell array 762. At line 705, the RSSI thresholds and gray lists, along with other user-configurable data, may be updated at the reconfigurable metasurface MCU 766.

The method 701 further includes, at line 707, the information handling system 700 sending a connection request with the access point 744. By operatively and wirelessly coupling the information handling system 700 to the access point 744, the information handling system 700 may, via the operation of the metasurface unit cell array 762, transmit and receive data via wireless transmissions in a radiofrequency environment with an enhanced wireless transmission reflected by the reconfigurable metasurface unit cell array 762 such as shown at line 735 and line 737 with the access point exchanging data with the information handling system 700.

At line 709, the method 701 includes the access point 744 providing wireless network data of the radiofrequency environment for wireless transmissions, such as between information handling system 700 and access point 744, as described in embodiments herein. This wireless network data may include, for example, data describing current channel congestion rates, current RSSI levels for each of the wireless communications, frequencies used within the wireless network, among other real-time wireless network data for that wireless network in the radiofrequency environment. In an embodiment, this wireless network data may be updated to the reconfigurable metasurface MCU 766 on a regular basis such that changes to wireless network characteristics and wireless network devices within the one or more wireless networks in a radiofrequency environment may be relayed to the reconfigurable metasurface MCU 766 with sufficient time for the reconfigurable metasurface MCU 766 to reconfigure the metasurface unit cell array 762 as described herein in order to improve operation of the reconfigurable metasurface unit cell array 762 to reflect plural wireless transmissions of allocated channels of the wireless network or networks in the radiofrequency environment.

At line 711, after the wireless network data, RSSI thresholds, and gray lists have been received, the reconfigurable metasurface MCU 766 invokes the dynamic metasurface configuration system 768 for processing to determine an optimal configuration of subsections of addressable reconfigurable unit cells. In an example embodiment, the dynamic metasurface configuration system 768 may include a deep reinforcement learning algorithm 770 that implements ML model techniques to define if and how to form reconfigurable metasurface unit cell subsections at the metasurface unit cell array 762 to improve gain for RSSI levels for some portion of allocated channels for wireless transmissions in the radiofrequency environment. It is appreciated that, during execution of machine readable code instructions of the dynamic metasurface configuration system 768 and its deep reinforcement learning algorithm 770, the deep reinforcement learning algorithm 770 may engage in retraining and/or training using a feedback loop that identifies any discrepancies between predicted and actual network performance thereby allowing for fine-tuning of the dynamic metasurface configuration system 768 and control algorithms such as the deep reinforcement learning algorithm 770.

At line 713, the output from the dynamic metasurface configuration system 768 may be received by the reconfigurable metasurface MCU 766 for implementation to allocate addressable reconfigurable metasurface unit cells among subsections of the reconfigurable metasurface unit cell array 762. In an embodiment, the reconfigurable metasurface MCU 766 may access a segmentation look-up table to determine current subsections and define how the dynamically-created reconfigurable metasurface unit cell subsections are to be adjusted to add addressable rows and columns of an adjacent plurality of addressable reconfigurable metasurface unit cells are to be added or subtracted among the subsections of the reconfigurable metasurface unit cell array 762.

At line, 715, the reconfigurable metasurface MCU 766 may send instructions to the metasurface controller 772 (e.g., FPGA) for the metasurface controller 772 to address each of the addressable reconfigurable metasurface unit cells within the metasurface unit cell array 762, such as by rows or columns as described herein, to allocate them to one or more reconfigurable metasurface unit cell subsections as described herein. In an embodiment, the instructions from the reconfigurable metasurface MCU 766 may include data describing location of each specific reconfigurable metasurface unit cells described in terms of a specific column of unit cells and row of unit cells that the metasurface controller 772 is to address for reconfiguration according to the principles described in, for example, FIG. 3. At line 717, the method continues with the metasurface controller 772 slicing the metasurface such that one or more reconfigurable metasurface unit cell subsections are to have addressable reconfigurable metasurface unit cells allocated. Voltage and current may be applied via contact pads at those addressable reconfigurable metasurface unit cells to adjust the reconfigurable resonant structures of those addressable reconfigurable metasurface unit cells to alter phase shifting of incoming EM waves to operate with adjacent addressable reconfigurable metasurface unit cells of a designated subsection according to embodiments herein. In this way, portions of addressable reconfigurable metasurface unit cells may be allocated to or amongst neighboring subsections in metasurface “slices” to expand or contract those subsections to improve RSSI gain of reflected signal by some of those subsections as determined by an optimal configuration from the dynamic metasurface configuration system 768. Other subsections may be contracted if those wireless transmissions are not in need of enhanced RSSI gain or serve lower priority wireless devices in the radiofrequency environment in embodiments herein.

It is appreciated that, as real-time wireless network data changes, updates to the dynamically-created reconfigurable metasurface unit cell subsections may be made via operation of the reconfigurable metasurface MCU 766, metasurface controller 772, and metasurface unit cell array 762 such as those processes described in lines 719 through 729. Indeed, at line 719, the access point 744 may determine if real-time wireless network data has changed. Where it has not, the configuration of reconfigurable metasurface unit cell subsections on the metasurface unit cell array 762 may remain. However, if real-time wireless network data has changed at line 719, the method 701 includes, at line 721, with the access point 744 providing this new real-time wireless network data to the reconfigurable metasurface MCU 766. Similar to above, the new real-time wireless network data is used as input at the dynamic metasurface configuration system 768 after the reconfigurable metasurface MCU 766 has provided this data at line 723. Updated output is sent back to the reconfigurable metasurface MCU 766 that describes an updated metasurface configuration at line 725. The updated metasurface slinging data is sent to the metasurface controller 772 at line 727 with the metasurface controller 772 again addressing the appropriate addressable reconfigurable metasurface unit cells within the metasurface unit cell array 762 to adjust to form newly sized or allocated reconfigurable metasurface unit cell subsections within the metasurface unit cell array 762 for wireless transmission reflected within the radiofrequency environment.

In an embodiment, and in order to further train and retrain the dynamic metasurface configuration system 768, the reconfigurable metasurface MCU 766 may transmit performance metrics to the information handling system 700 at line 731. The user, in an embodiment, may determine if those RSSI thresholds, gray list data, device prioritization data, and other operational characteristics should be altered in order to improve the performance of the metasurface unit cell array 762. At line 733, the method 701 includes updating model parameters with the new RSSI thresholds, gray list data, device prioritization data, and other operational characteristics.

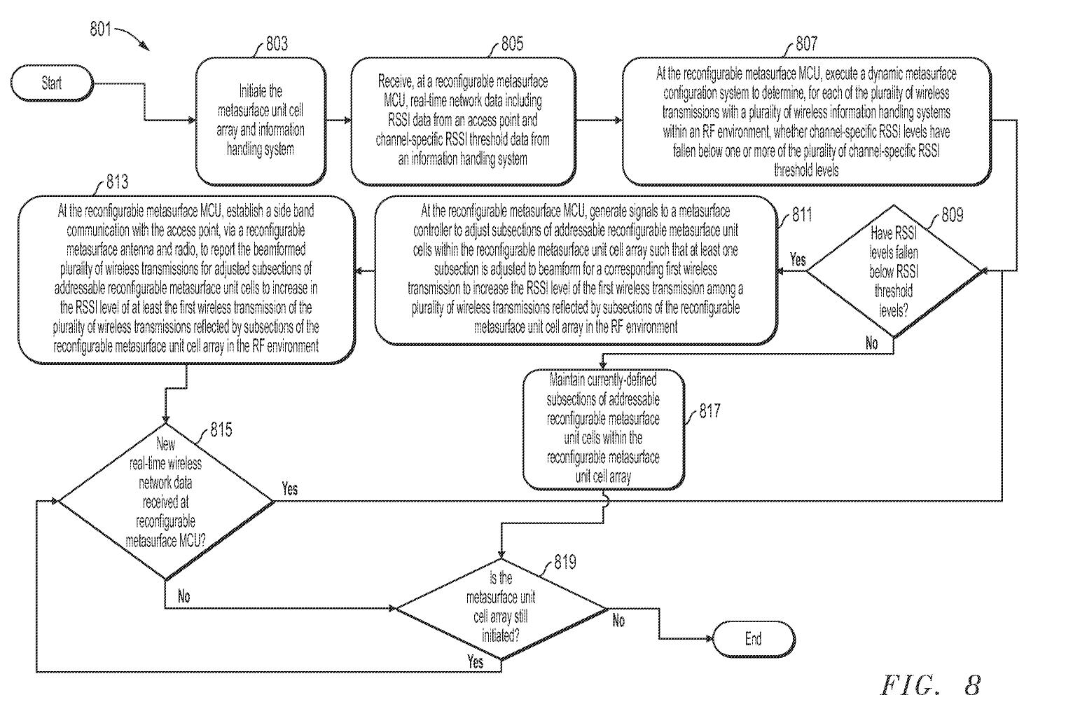

FIG. 8 is a block diagram of a method 801 of allocating addressable reconfigurable metasurface unit cells in subsections of a reconfigurable metasurface unit cell array for allocated channels of wireless transmissions in a radiofrequency environment according to another embodiment of the present disclosure. The method 801 described in connection with FIG. 8 may be implemented on any of the information handling systems and reconfigurable metasurface unit cell arrays described in connection with, for example, FIGS. 3-6.

At block 803, the method 801 may include initiating the metasurface unit cell array and one or more information handling systems in a radiofrequency environment. In an embodiment, the metasurface unit cell array may be initiated by a user accessing a power button that activates a metasurface PMU to provide power to the metasurface. Additionally, the information handling system may be initiated by a user accessing a power button that activates a PMU of the information handling system to provide power to the information handling system.

At block 805, the method 800 includes receiving, at a reconfigurable metasurface MCU, real-time network data including RSSI data from an access point and channel-specific RSSI threshold data from an information handling system within a radiofrequency environment in which the reconfigurable metasurface unit cell array is operating. The wireless network data for the radiofrequency environment exchanged with the reconfigurable metasurface unit cell array includes RSSI data and RSSI threshold data that is received by the reconfigurable metasurface MCU. The present specification contemplates that other wireless network data for the radiofrequency environment may be exchanged as well such as device prioritization data, channel state information describing how the plurality of wireless transmissions are transmitted between each of the transmitter device and receiver device in terms of amplitude and phase, user device density within the wireless network, frequency channels currently being used by one or more information handling systems within the wireless network, device-specific optimization data, device prioritization data, current channel congestion rates, among other real-time wireless network data described herein. Such wireless network data for the radiofrequency environment may be used as inputs during the execution of machine readable code instructions of the dynamic metasurface configuration system and deep reinforcement learning algorithm of embodiments of the present disclosure.

At block 807, the reconfigurable metasurface MCU may execute machine readable program code instructions of a dynamic metasurface configuration system to determine, for each of the plurality of wireless transmissions of one or more wireless networks with a plurality of wireless information handling systems within a radiofrequency environment, whether channel-specific RSSI levels have fallen below one or more of the plurality of channel-specific RSSI threshold levels.

Thus, at block 809, the MCU may determine whether currently detected RSSI levels at the access point and received at the reconfigurable metasurface MCU have fallen below RSSI threshold levels set by the user at the information handling system. Where the RSSI levels have not fallen below the set RSSI threshold levels, at block 809, the method 801 continues to block 817 with the reconfigurable metasurface MCU maintaining currently-defined subsections of addressable reconfigurable metasurface unit cells within the reconfigurable metasurface unit cell array. This allows the metasurface unit cell array to remain in a current configuration until the wireless network data indicates that the reconfigurable metasurface unit cell subsections should be changed.

At block 809 where the RSSI levels have been determined to fall below the threshold level, the method 801 continues to block 811. At block 811, the reconfigurable metasurface MCU execute machine readable code instruction of the dynamic metasurface configuration system identify and address specific addressable reconfigurable metasurface unit cells so that a dynamically-created reconfigurable metasurface unit cell subsection may be adjusted with more or fewer addressable reconfigurable metasurface unit cells to improve RSSI gain reflected by that dynamically-created reconfigurable metasurface unit cell subsection. Adjustment of the addressable reconfigurable metasurface unit cells attributed to a dynamically-created reconfigurable metasurface unit cell subsection may be increased in number to increase gain of the reflected EM waves of wireless transmissions reflected by that dynamically-created reconfigurable metasurface unit cell subsection so that RSSI thresholds may be met. For example, where a specific dynamically-created reconfigurable metasurface unit cell subsection assigned to a specific wireless frequency channel is being used to reflect a wireless transmission and the RSSI value for that wireless frequency channel has fallen below the channel-specific RSSI threshold, additional reconfigurable metasurface unit cells may be added to a corresponding dynamically-created reconfigurable metasurface unit cell subsection in order to increase the gain for that wireless frequency reflected from that dynamically-created reconfigurable metasurface unit cell subsection. This process may be conducted for any wireless frequency of wireless transmissions that are being reflected off of the surface of the reconfigurable metasurface unit cell array in the radiofrequency environment.

With identification of re-allocation of addressable reconfigurable metasurface unit cells to one or more subsections, the reconfigurable metasurface MCU may generate signals to a metasurface controller to adjust subsections of addressable reconfigurable metasurface unit cells within the addressable reconfigurable metasurface unit cell array. In this way, at least one subsection is adjusted to beamform for a corresponding first wireless transmission to increase the RSSI level of the first wireless transmission reflected by that dynamically-created reconfigurable metasurface unit cell subsection of the reconfigurable metasurface unit cell array that has fallen below an RSSI threshold level. Adjustments may be made to reflection by plural subsections among the plurality of wireless transmissions in the radiofrequency environment. As described herein, the reconfigurable metasurface MCU may execute machine readable program code of a dynamic metasurface configuration system to define how to segment the reconfigurable metasurface unit cells of the metasurface unit cell array into individual dynamically-created reconfigurable metasurface unit cell subsections. In an example embodiment, the dynamic metasurface configuration system may include a deep reinforcement learning algorithm that implements machine learning (ML) model techniques. Additionally, it is appreciated that, during execution of the dynamic metasurface configuration system and its deep reinforcement learning algorithm, the deep reinforcement learning algorithm may engage in retraining and/or training using a feedback loop that identifies any discrepancies between predicted and actual network performance thereby allowing for fine-tuning of the dynamic metasurface configuration system and ML algorithms such as the deep reinforcement learning algorithm.

The output from the execution of machine readable code instructions of the dynamic metasurface configuration system and its deep reinforcement learning algorithm may be used by the reconfigurable metasurface MCU to define how to segment the metasurface unit cell array into one or more dynamically-created reconfigurable metasurface unit cell subsections through the reconfigurable metasurface MCU addressing specific addressable reconfigurable metasurface unit cells as described in connection with embodiments herein to adjust resonant structures thereon to modify phase shift of incoming EM waves of wireless transmissions. By providing a power or current pulse to contact pads of the addressable reconfigurable metasurface unit cells, the resonant structures may be modified to alter phase change of incoming EM waves to operate in connection with adjacent addressable reconfigurable metasurface unit cells of a designated dynamically-created reconfigurable metasurface unit cell subsection via constructive or destructive interference among those reflected frequencies. In an embodiment, the reconfigurable metasurface MCU may access a segmentation look-up table to define how the dynamically-created reconfigurable metasurface unit cell subsections are to be created using which of a plurality of addressable reconfigurable metasurface unit cells to provide increased gain or directionality for a particular wireless transmission with allocated channel in the radiofrequency environment. In an embodiment, the segmentation look-up table may include data describing how many reconfigurable metasurface unit cells may be needed to be added and phase shift adjustments needed for those addressable reconfigurable metasurface unit cells to be allocated to any given dynamically-created reconfigurable metasurface unit cell subsection in order to increase the RSSI values above a RSSI threshold value.

For example, the output from the dynamic metasurface configuration system may define that a specifically identified wireless transmission at a specified frequency from a network device that has a certain level of priority in a radiofrequency environment may require a defined number of reconfigurable metasurface unit cells devoted to a single dynamically-created reconfigurable metasurface unit cell subsection designated to reflect that specifically identified wireless transmission. In this way, the specifically identified wireless transmission may be redirected from off of the surface of the metasurface unit cell array in a specific direction using beamforming techniques and a necessary gain in the radiofrequency environment by that single dynamically-created reconfigurable metasurface unit cell subsection. The reconfigurable metasurface MCU may then, with the information from the segmentation look-up table, create a subsection of addressable reconfigurable metasurface unit cells within the reconfigurable metasurface unit cell array to beamform the plurality of wireless transmissions, including the specifically identified wireless transmission, and increase the RSSI levels of one or more of the plurality of wireless transmissions to wireless information handling systems operatively coupled to wireless networks in the radiofrequency environment. Other wireless transmissions with lower priority or not needing as much gain may have corresponding dynamically-created reconfigurable metasurface unit cell subsections reduced in number of addressable reconfigurable metasurface unit cells in other embodiments so that the addressable reconfigurable metasurface unit cells across the reconfigurable metasurface unit cell array may be allocated to plural wireless transmissions in the radiofrequency environment.

At block 813, the reconfigurable metasurface MCU may, via an established side band communication with the access point, report the adjustment of dynamically-created reconfigurable metasurface unit cell subsections of the reconfigurable metasurface unit cell array and corresponding predicted beamforming of the plurality of wireless transmissions and increase in the RSSI levels of at least the first wireless transmission of the plurality of wireless transmissions reflected by subsections of the reconfigurable metasurface unit cell array in the radiofrequency environment. This may be done so as to further train and retrain the dynamic metasurface configuration system with the reconfigurable metasurface MCU transmitting performance metrics to the information handling systems or access points within the radiofrequency environment. This predicted beamforming for the plurality of wireless transmissions and increase in the RSSI levels of at least the first wireless transmission of the plurality of wireless transmissions reflected by subsections of the reconfigurable metasurface unit cell array in the radiofrequency environment may then be compared to detected RSSI levels and other real-time wireless network performance data of the radiofrequency environment which may be reported back to the reconfigurable metasurface unit cell array and the reconfigurable metasurface MCU executing the dynamic metasurface configuration system. The user, in some embodiments, may also determine if those RSSI thresholds, gray list data, device prioritization data, and other operational characteristics should be altered in order to improve the performance of the metasurface unit cell array. This data may be provided to the reconfigurable metasurface MCU with the reconfigurable metasurface MCU updating model parameters with the new RSSI thresholds, gray list data, device prioritization data, and other operational characteristics.

At block 815 the method 800 may include a determination whether new real-time wireless network data is received at the reconfigurable metasurface MCU from the access point and information handling system. Where new real-time wireless network data is received, the method 801 may continue to block 809 with the reconfigurable metasurface MCU determining whether this new data indicates RSSI levels have fallen below the RSSI threshold levels as described in embodiments herein.

Where, at block 815, new real-time wireless network data has not been received, the method 801 continues to block 819. At block 819, the method 801 includes determining if the reconfigurable metasurface unit cell array and information handling system are still initiated. Where the reconfigurable metasurface unit cell array and information handling system are still initiated, the method 801 proceeds to block 815 with the reconfigurable metasurface MCU determining if new real-time wireless network data has been received as described herein. Where the reconfigurable metasurface unit cell array or information handling system are no longer initiated, the method 801 may end here.

The processes or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A reconfigurable metasurface unit cell array comprising:
a dielectric substrate and a plurality of addressable reconfigurable metasurface unit cells formed thereon, wherein each addressable reconfigurable metasurface unit cell includes plural resonant structures reconfigurable to adjust reflective phase shift patterns for each addressable reconfigurable metasurface unit cell;
a reconfigurable metasurface microcontroller unit (MCU) to receive real-time network data, via a reconfigurable metasurface wireless adapter, from an access point describing received signal strength indicator (RSSI) data associated with a plurality of wireless transmissions for a plurality of wireless information handling systems within a radiofrequency environment and a plurality of channel-specific RSSI threshold levels set by an information technology decision maker (ITDM);
the reconfigurable metasurface MCU to execute machine readable code instructions of dynamic metasurface configuration system to determine, for each of the plurality of wireless transmissions for each of the plurality of wireless information handling systems within the radiofrequency environment, whether channel-specific RSSI levels have fallen below one or more of the plurality of channel-specific RSSI threshold levels; and
the reconfigurable metasurface MCU to, when channel-specific RSSI levels have fallen below one or more of the plurality of channel-specific RSSI threshold levels, generate signals to a metasurface controller to address groups of addressable reconfigurable metasurface unit cell to adjust plural subsections of the addressable reconfigurable metasurface unit cells within the reconfigurable metasurface unit cell array corresponding for each of the plurality of wireless transmissions in the radiofrequency environment to allocate at least one subsection of the addressable reconfigurable metasurface unit cells to beamform a first wireless transmission to increase the RSSI level of the first wireless transmission from the plurality of wireless transmissions reflected by the plurality of subsections of the addressable reconfigurable metasurface unit cells of the reconfigurable metasurface unit cell array.

2. The reconfigurable metasurface unit cell array of claim 1 further comprising:
the addressable reconfigurable metasurface unit cells including the plural resonant structures reconfigurable to adjust reflective phase shift patterns for each addressable reconfigurable metasurface unit cell having plural metasurface reconfigurable split rings of state-shifting material with corresponding refractory heaters to switch the corresponding metasurface reconfigurable split ring between a conductive state and dielectric state to adjust capacitance of the plural resonant structures of the reconfigurable metasurface unit cell;
and the reconfigurable metasurface MCU to selectively provide power to some portion of the plural refractory heaters to change the electromagnetic reflective properties of the array of reconfigurable metasurface unit cells to conduct beamforming.

3. The reconfigurable metasurface unit cell array of claim 1 further comprising:
the addressable reconfigurable metasurface unit cells including the plural resonant structures reconfigurable to adjust reflective phase shift patterns for each addressable reconfigurable metasurface unit cell having plural metasurface switchable capacitance structures to switch the corresponding capacitance of the reconfigurable metasurface unit cell; and
the reconfigurable metasurface MCU to selectively switch some portion of the capacitance of the resonant structures of each addressable reconfigurable metasurface unit cell to change the electromagnetic reflective properties and phase shift of the radiofrequency transmission to conduct beamforming in a subsection of the reconfigurable metasurface unit cell array.

4. The reconfigurable metasurface unit cell array of claim 1, wherein the addressable reconfigurable metasurface unit cells are arranged within the reconfigurable metasurface unit cell array in columns and rows for the reconfigurable metasurface MCU to adjust a size of subsections of the addressable reconfigurable metasurface unit cells to include a first number of neighboring cells from one or more rows in one or more columns addressed as part of subsections to increase a size of the subsections of the addressable reconfigurable metasurface unit cells for reflection of particular wireless transmissions in the radiofrequency environment.

5. The reconfigurable metasurface unit cell array of claim 1 further comprising:
the reconfigurable metasurface MCU to execute machine readable code instructions of dynamic metasurface configuration system to establish a side band communication with the access point, via a reconfigurable metasurface antenna and radio, to report the beamformed plurality of wireless transmissions and increases in the RSSI levels of the plurality of wireless transmissions of a plurality of wireless information handling system.

6. The reconfigurable metasurface unit cell array of claim 1 further comprising:
the reconfigurable metasurface wireless adapter receiving the real-time network data including channel state information describing how the plurality of wireless transmissions are transmitted between each of a transmitter device and a receiver device in terms of amplitude and phase in the radiofrequency environment for dynamic channel allocation to wireless transmission channels with lower congestion.

7. The reconfigurable metasurface unit cell array of claim 1 further comprising:
the reconfigurable metasurface MCU operating with a metasurface controller field programmable gate array (FPGA) to access a look-up table defining how the metasurface controller FPGA is to address and activate each of the addressable reconfigurable metasurface unit cells of the reconfigurable metasurface unit cell array to adjust the subsections of addressable reconfigurable metasurface unit cells within the reconfigurable metasurface unit cell array for each of the plurality of wireless transmissions reflected by the plurality of subsections of the addressable reconfigurable metasurface unit cells of the reconfigurable metasurface unit cell array.

8. The reconfigurable metasurface unit cell array of claim 1, wherein the real-time network data includes device-specific optimization data, gray list data, and device prioritization data.

9. The reconfigurable metasurface unit cell array of claim 8 further comprising:
the reconfigurable metasurface MCU to execute machine readable code instructions of dynamic metasurface configuration system including executing machine readable code instructions of a deep reinforcement learning algorithm to receive the RSSI data, device-specific optimization data, gray list data, and device prioritization data, and generate adjustments to the subsections of addressable reconfigurable metasurface unit cells within the reconfigurable metasurface unit cell array to beamform the first wireless transmission to increase the RSSI levels of the first wireless transmission among the plurality of wireless transmissions with the plurality of wireless information handling systems within the radiofrequency environment.

10. A method of allocating wireless channels in a radiofrequency environment using a reconfigurable metasurface unit cell array comprising:
with a reconfigurable metasurface wireless adapter, receiving real-time network data from an access point describing received signal strength indicator (RSSI) data associated with a plurality of wireless transmissions with a plurality of wireless information handling systems within the radiofrequency environment, and a plurality of channel-specific RSSI threshold levels set by an information technology decision maker (ITDM);
with the reconfigurable metasurface microcontroller unit (MCU), executing computer readable code instructions of dynamic metasurface configuration system to determine, for each of the plurality of wireless transmissions with the plurality of wireless information handling systems within the radiofrequency environment, whether channel-specific RSSI levels have fallen below one or more of the plurality of channel-specific RSSI threshold levels;
with the reconfigurable metasurface MCU, when the channel-specific RSSI level of at least a first wireless transmission has fallen below one or more of the plurality of channel-specific RSSI threshold levels, executing computer readable code instructions of a dynamic metasurface configuration system to generate signals to a metasurface controller to adjust a first subsection of addressable reconfigurable metasurface unit cells within the reconfigurable metasurface unit cell array to beamform for the first wireless transmission to increase the RSSI level among the plurality of wireless transmissions with the radiofrequency environment, wherein each addressable reconfigurable metasurface unit cell includes plural reconfigurable resonant structures to adjust reflective phase shift patterns for each addressable reconfigurable metasurface unit cell; and
with the reconfigurable metasurface MCU, executing computer readable code instructions of the dynamic metasurface configuration system to establish a side band communication with an access point in the radiofrequency environment to report the adjustment in the subsections for the increase in the RSSI level of the first wireless transmission.

11. The method of claim 10 further comprising:
adjusting the phase shift patterns of the addressable reconfigurable metasurface unit cells with the reconfigurable resonant structures including plural metasurface reconfigurable split rings of a state-shifting material with corresponding refractory heaters to switch the corresponding metasurface reconfigurable split ring between a conductive state and dielectric state to adjust capacitance of the reconfigurable resonant structures for the reconfigurable metasurface unit cell; and
selectively providing power with the reconfigurable metasurface MCU to some portion of the plural refractory heaters to change the electromagnetic reflective properties of the reconfigurable resonant structures of the addressable reconfigurable metasurface unit cells to conduct beamforming with a subsection of the addressable reconfigurable metasurface unit cells.

12. The method of claim 10 further comprising:
executing computer readable code instructions of dynamic metasurface configuration system to generate signals to a metasurface controller to adjust a number of addressable reconfigurable metasurface unit cells allocated to the first subsection of addressable reconfigurable metasurface unit cells within the reconfigurable metasurface unit cell array to beamform for the first wireless transmission to increase the RSSI level among the plurality of wireless transmissions with the radiofrequency environment; and
adjusting the reflective phase shift patterns for each addressable reconfigurable metasurface unit cell of the number of addressable reconfigurable metasurface unit cells allocated to the first subsection of addressable reconfigurable metasurface unit cells by adjustment to the reconfigurable plural reconfigurable resonant structures.

13. The method of claim 10, wherein the addressable reconfigurable metasurface unit cells are arranged within the reconfigurable metasurface unit cell array in columns and rows for the reconfigurable metasurface MCU to adjust a size of subsections of reconfigurable metasurface unit cells by including a first number of neighboring addressable reconfigurable metasurface cells from one or more rows or one or more columns adjacent to a subsection being increased in size to increase RSSI level for a corresponding wireless transmission reflected by that subsection.

14. The method of claim 10, wherein the computer readable code instructions of dynamic metasurface configuration system includes a deep reinforcement learning algorithm to receive the real-time network data including device-specific optimization data, gray list data, and device prioritization data to adjust the subsections of addressable reconfigurable metasurface unit cells within the reconfigurable metasurface unit cell array determine adjustments to beamform the plurality of wireless transmissions and increase the RSSI level of the first wireless transmission to a receiver wireless information handling system from among the plurality of wireless transmissions reflected by the reconfigurable metasurface unit cell array in the radiofrequency environment.

15. A reconfigurable metasurface unit cell array comprising:
a dielectric substrate and a plurality of addressable reconfigurable metasurface unit cells formed thereon, wherein each addressable reconfigurable metasurface unit cell includes plural resonant structures reconfigurable to adjust reflective phase shift patterns for each addressable reconfigurable metasurface unit cell;
a reconfigurable metasurface microcontroller unit (MCU) to receive real-time network data, via a reconfigurable metasurface wireless adapter, from an access point describing received signal strength indicator (RSSI) data associated with a plurality of wireless transmissions for a plurality of wireless information handling systems within a radiofrequency environment and a plurality of channel-specific RSSI threshold levels set by an information technology decision maker (ITDM);
the reconfigurable metasurface MCU to execute machine readable code instructions of dynamic metasurface configuration system to determine, for each of the plurality of wireless transmissions for each of the plurality of wireless information handling systems within the radiofrequency environment, whether channel-specific RSSI levels have fallen below one or more of the plurality of channel-specific RSSI threshold levels; and
the reconfigurable metasurface MCU to, when channel-specific RSSI levels have fallen below one or more of the plurality of channel-specific RSSI threshold levels, generate signals to a metasurface controller to address groups of addressable reconfigurable metasurface unit cell to adjust plural subsections of the addressable reconfigurable metasurface unit cells within the reconfigurable metasurface unit cell array corresponding for each of the plurality of wireless transmissions in the radiofrequency environment to adjust at least one subsection of the addressable reconfigurable metasurface unit cells to increase the RSSI level of a first wireless transmission from the plurality of wireless transmissions reflected by the plurality of subsections of the addressable reconfigurable metasurface unit cells of the reconfigurable metasurface unit cell array,
wherein the dynamic metasurface configuration system includes a deep reinforcement learning algorithm to receive the RSSI data, device-specific optimization data, gray list data, and device prioritization data to allocate addressable reconfigurable metasurface unit cells to adjust the size of the subsections of the addressable reconfigurable metasurface unit cells within the reconfigurable metasurface unit cell array for each of the plurality of wireless transmissions in the radiofrequency environment.

16. The reconfigurable metasurface unit cell array of claim 15 further comprising:
the addressable reconfigurable metasurface unit cells including the plural resonant structures reconfigurable to adjust reflective phase shift patterns for each addressable reconfigurable metasurface unit cell having resonant structures that are switchable between a conductive state and dielectric state to adjust capacitance of the plural resonant structures of the reconfigurable metasurface unit cell; and
the reconfigurable metasurface MCU to selectively provide power to adjust the conductive state and dielectric state of some of the resonant structures to change the electromagnetic reflective properties of the addressable reconfigurable metasurface unit cell to a subsection to conduct beamforming with that subsection of addressable reconfigurable metasurface unit cells.

17. The reconfigurable metasurface unit cell array of claim 15 further comprising:
the addressable reconfigurable metasurface unit cells including the plural resonant structures reconfigurable to adjust reflective phase shift patterns for each addressable reconfigurable metasurface unit cell includes a metasurface switchable capacitance structure to switch the corresponding capacitance of the reconfigurable metasurface unit cell; and
the reconfigurable metasurface MCU to selectively switch some portion of the capacitance of the resonant structures of each addressable reconfigurable metasurface unit cell to change the electromagnetic reflective properties and phase shift of the radiofrequency transmission to conduct beamforming in a subsection of the reconfigurable metasurface unit cell array.

18. The reconfigurable metasurface unit cell array of claim 15, wherein the addressable reconfigurable metasurface unit cells are arranged within the reconfigurable metasurface unit cell array in columns and rows for the reconfigurable metasurface MCU to adjust the size of subsections of the addressable reconfigurable metasurface unit cells to include a first number of neighboring cells from one or more rows in one or more columns addressed as part increasing the size of the at least one subsection of the addressable reconfigurable metasurface unit cells for reflection of the first wireless transmission in the radiofrequency environment.

19. The reconfigurable metasurface unit cell array of claim 15 further comprising:
the reconfigurable metasurface MCU to execute machine readable code instructions of dynamic metasurface configuration system to establish a side band communication with the access point, via the reconfigurable metasurface wireless adapter, to report the adjustment to the at least one subsection of the addressable reconfigurable metasurface unit cells to increase the RSSI level of the first wireless transmission of the plurality of wireless transmissions reflected by the plurality of subsections of the addressable reconfigurable metasurface unit cells of the reconfigurable metasurface unit cell array.

20. The reconfigurable metasurface unit cell array of claim 15 further comprising:
the reconfigurable metasurface wireless adapter receiving the real-time network data including channel state information describing how the plurality of wireless transmissions are transmitted between each of a transmitter device and a receiver device in terms of amplitude and phase in the radiofrequency environment for dynamic channel allocation to wireless transmission channels with lower congestion.
